(19) United States
(12) Patent Application Publication
(10) Pub. No.: US 2026/0290362 A1
(43) Pub. Date: Sep. 24, 2026

(54) Apparatus and Method for Audio Signal Coding with Temporal Noise Shaping on Subband Signals

(71) Applicant: Fraunhofer-Gesellschaft zur Förderung der angewandten Forschung e.V., München (DE)

(72) Inventors: Richard FÜG, Erlangen (DE); Bernd EDLER, Erlangen (DE)

(21) Appl. No.: 19/362,989

(22) Filed: Oct. 20, 2025

Related U.S. Application Data
(63) Continuation of application No. PCT/EP2024/060791, filed on Apr. 19, 2024.

(30) Foreign Application Priority Data
Apr. 21, 2023 (EP) 23169234.4

(51) Int. Cl. G10L 19/02; G10L 19/03

(52) U.S. Cl. CPC G10L 19/0216; G10L 19/03

(57) ABSTRACT

An apparatus for audio signal decoding according to an embodiment is provided. The apparatus comprises a decoding unit configured for decoding an audio signal encoding to obtain a decoded spectral-domain audio signal and modification information, wherein the decoded spectral-domain audio signal comprises a plurality of spectral coefficients. Moreover, the apparatus comprises a first transform unit configured for transforming the decoded spectral-domain audio signal from a spectral domain to a subband signal domain to obtain a subband-signal-domain-transformed audio signal comprising a plurality of subband signals. Furthermore, the apparatus comprises a subband signal modifier configured for obtaining a modified subband-signal-domain audio signal by modifying, depending on the modification information, one or more subband signals of the plurality of subband signals of the subband-signal-domain-transformed audio signal. Moreover, the apparatus comprises a second transform unit configured for transforming the modified subband-signal-domain audio signal from the subband signal domain to the spectral domain.

### CROSS-REFERENCE TO RELATED APPLICATIONS

This application is a continuation of copending International Application No. PCT/EP2024/060791, filed Apr. 19, 2024, which is incorporated herein by reference in its entirety, and additionally claims priority from European Application No. EP23169234.4, filed Apr. 21, 2023, which is also incorporated herein by reference in its entirety.

The present invention relates to temporal noise shaping on subband signals, in particular, to an apparatus and method for audio signal encoding and to an apparatus and method for audio signal decoding, which support temporal noise shaping on subband signals, more particularly, which support temporal noise shaping on MDCT subband signals.

### BACKGROUND OF THE INVENTION

Coding in the transform domain is a method employed in many state-of-the-art codecs for general audio coding. At the encoder side, it requires the audio signal to be split into frames, that are windowed and then transformed into a spectral domain. These short-time spectra are then quantized and entropy coded before transmission to the decoder, where they are transformed back into time domain. A common choice for the transform is the Modified Discrete Cosine Transform (MDCT).

As the quantization for transmission is performed in the spectral domain, different quantizer step widths can be chosen for different frequency regions. This allows for the exploitation of the simultaneous masking effect of the human hearing system, which in return can result in low transmission bitrate while maintaining good perceptual quality. Having this control over the spectral distribution of the quantization noise comes with the disadvantage, that control over the temporal distribution of the quantization noise is not straightforward, which results in the quantization noise spread out over the entire transform window. This can become a problem for transient signals, where simultaneous masking is only strong during the duration of the transient, whereas temporal masking is usually only strong after the transient. Thus unmasking of the quantization noise and degradation of perceptual quality can occur.

A common artifact resulting from this is the so-called pre-echo.

Several methods were introduced to overcome this issue. The pre-echo control approach detects critical cases and tries to avoid artifacts by applying finer quantization. However this approach leads to a significant increase in bitrate.

Window switching [1] allows the codec to change the length of the transform window, allowing for long windows for stationary signals and short windows for transient signals. The latter limits the spread of the quantization noise to the borders of the short window and thereby effectively reduces temporal unmasking. However, not only does using shorter window reduce coding efficiency, depending on the implementation also lookahead for the window switching decision might be required, resulting in an increased overall system delay. Gain control methods [2][3][4] try to flatten the signal temporally before feeding it to the encoder and reshape the original temporal envelope after decoding. This results in the quantization noise being temporally shaped similarly to the temporal envelope of the original signal. As the temporal behavior of signals is often different in different frequency regions, usually gain control employs an auxiliary filterbank before the encoder and after the decoder. Not only does this require higher computational complexity, it might also increase the overall delay of the system. Furthermore gain control has to transmit side information for the flattening/reshaping process. This can be in form of explicit gains [2][3] or side information to estimate gains at encoder/decoder [4].

With Temporal Noise Shaping (TNS) [5] based on Linear Predictive Coding (LPC) a method was introduced, that follows a similar concept as gain control, but works entirely in the transform domain. It applies open-loop LPC as known from time domain coding of audio to the spectrum. Just like open-loop LPC in time domain results in the quantization noise being spectrally shaped similar to the original, LPC in transform domain, being the transform dual process, results in the quantization noise being temporally shaped similar to the original signal. As the Linear Prediction (LP) filter is applied to the spectrum, it is straightforward to use different filters for different frequency regions accounting for different temporal behavior respectively. The filter is transmitted to the decoder as side information. In state-of-the-art codecs this is done using Reflection Coefficients (RCs) quantized in arcsine domain followed by entropy coding.

### SUMMARY

According to an embodiment, an apparatus for audio signal decoding may have: a decoding unit configured for decoding an audio signal encoding to obtain a decoded spectral-domain audio signal and modification information, wherein the decoded spectral-domain audio signal includes a plurality of spectral coefficients, a first transform unit configured for transforming the decoded spectral-domain audio signal from a spectral domain to a subband signal domain to obtain a subband-signal-domain-transformed audio signal including a plurality of subband signals, a subband signal modifier configured for obtaining a modified subband-signal-domain audio signal by modifying, depending on the modification information, one or more subband signals of the plurality of subband signals of the subband-signal-domain-transformed audio signal, and a second transform unit configured for transforming the modified subband-signal-domain audio signal from the subband signal domain to the spectral domain to obtain a reconstructed spectral-domain audio signal.

According to another embodiment, an apparatus for audio signal encoding may have: a first transform unit configured for transforming a first spectral-domain audio signal including a plurality of spectral coefficients from a spectral domain to a subband signal domain to obtain a subband-signal-domain-transformed audio signal including a plurality of subband signals, a subband signal modifier configured for modifying one or more subband signals of the plurality of subband signals of the subband-signal-domain-transformed audio signal to obtain a modified subband-signal-domain audio signal, a second transform unit configured for transforming the modified subband-signal-domain audio signal from the subband signal domain to the spectral domain to obtain a modified spectral-domain audio signal, and an encoding unit configured for generating an audio signal encoding which includes an encoding of the modified spectral-domain audio signal and modification information or an encoding thereof, wherein the modification information includes information on how the one or more subband signals have been modified.

According to another embodiment, a system may have: an inventive apparatus for audio signal encoding, and an inventive apparatus for audio signal decoding, wherein the inventive apparatus for audio signal decoding is configured to receive the audio signal encoding being generated by the inventive apparatus for audio signal encoding.

According to another embodiment, a method for audio signal decoding may have the steps of: decoding an audio signal encoding to obtain a decoded spectral-domain audio signal and modification information, wherein the decoded spectral-domain audio signal includes a plurality of spectral coefficients, transforming the decoded spectral-domain audio signal from a spectral domain to a subband signal domain to obtain a subband-signal-domain-transformed audio signal including a plurality of subband signals, obtaining a modified subband-signal-domain audio signal by modifying, depending on the modification information, one or more subband signals of the plurality of subband signals of the subband-signal-domain-transformed audio signal, and transforming the modified subband-signal-domain audio signal from the subband signal domain to the spectral domain to obtain a reconstructed spectral-domain audio signal.

According to another embodiment, a method for audio signal encoding may have the steps of: transforming a first spectral-domain audio signal including a plurality of spectral coefficients from a spectral domain to a subband signal domain to obtain a subband-signal-domain-transformed audio signal including a plurality of subband signals, modifying one or more subband signals of the plurality of subband signals of the subband-signal-domain-transformed audio signal to obtain a modified subband-signal-domain audio signal, transforming the modified subband-signal-domain audio signal from the subband signal domain to the spectral domain to obtain a modified spectral-domain audio signal, and generating an audio signal encoding which includes an encoding of the modified spectral-domain audio signal and modification information or an encoding thereof, wherein the modification information includes information on how the one or more subband signals have been modified.

Another embodiment may have a non-transitory digital storage medium having a computer program stored thereon to perform any of the inventive methods when said computer program is run by a computer.

An apparatus for audio signal decoding according to an embodiment is provided. The apparatus comprises a decoding unit configured for decoding an audio signal encoding to obtain a decoded spectral-domain audio signal and modification information, wherein the decoded spectral-domain audio signal comprises a plurality of spectral coefficients. Moreover, the apparatus comprises a first transform unit configured for transforming the decoded spectral-domain audio signal from a spectral domain to a subband signal domain to obtain a subband-signal-domain-transformed audio signal comprising a plurality of subband signals. Furthermore, the apparatus comprises a subband signal modifier configured for obtaining a modified subband-signal-domain audio signal by modifying, depending on the modification information, one or more subband signals of the plurality of subband signals of the subband-signal-domain-transformed audio signal. Moreover, the apparatus comprises a second transform unit configured for transforming the modified subband-signal-domain audio signal from the subband signal domain to the spectral domain to obtain a reconstructed spectral-domain audio signal.

Moreover, an apparatus for audio signal encoding according to an embodiment is provided. The apparatus comprises a first transform unit configured for transforming a first spectral-domain audio signal comprising a plurality of spectral coefficients from a spectral domain to a subband signal domain to obtain a subband-signal-domain-transformed audio signal comprising a plurality of subband signals. Moreover, the apparatus comprises a subband signal modifier configured for modifying one or more subband signals of the plurality of subband signals of the subband-signal-domain-transformed audio signal to obtain a modified subband-signal-domain audio signal, Furthermore, the apparatus comprises a second transform unit configured for transforming the modified subband-signal-domain audio signal from the subband signal domain to the spectral domain to obtain a modified spectral-domain audio signal, and Moreover, the apparatus comprises an encoding unit configured for generating an audio signal encoding which comprises an encoding of the modified spectral-domain audio signal and modification information or an encoding thereof, wherein the modification information comprises information on how the one or more subband signals have been modified.

Furthermore, a method for audio signal decoding according to an embodiment is provided. The method comprises:
Decoding an audio signal encoding to obtain a decoded spectral-domain audio signal and modification information, wherein the decoded spectral-domain audio signal comprises a plurality of spectral coefficients.
Transforming the decoded spectral-domain audio signal from a spectral domain to a subband signal domain to obtain a subband-signal-domain-transformed audio signal comprising a plurality of subband signals.
Obtaining a modified subband-signal-domain audio signal by modifying, depending on the modification information, one or more subband signals of the plurality of subband signals of the subband-signal-domain-transformed audio signal. And:
Transforming the modified subband-signal-domain audio signal from the subband signal domain to the spectral domain to obtain a reconstructed spectral-domain audio signal.

Moreover, a method for audio signal encoding according to an embodiment is provided. The method comprises:
Transforming a first spectral-domain audio signal comprising a plurality of spectral coefficients from a spectral domain to a subband signal domain to obtain a subband-signal-domain-transformed audio signal comprising a plurality of subband signals.
Modifying one or more subband signals of the plurality of subband signals of the subband-signal-domain-transformed audio signal to obtain a modified subband-signal-domain audio signal.
Transforming the modified subband-signal-domain audio signal from the subband signal domain to the spectral domain to obtain a modified spectral-domain audio signal. And:
Generating an audio signal encoding which comprises an encoding of the modified spectral-domain audio signal and modification information or an encoding thereof, wherein the modification information comprises information on how the one or more subband signals have been modified.

Furthermore, a computer program according to an embodiment, for implementing one of the above-described methods, when being executed on a computer or signal processor is provided.

According to embodiments, new concepts are provided, that apply subband merging/splitting on the MDCT (Modified Discrete Cosine Transform) spectrum in encoder and decoder. This allows for modification of the temporal subband signals for different frequency ranges in a way that results in a flattening of the temporal envelope in the encoder before quantization and a reshaping to its original envelope at the decoder. The reshaping process at the decoder not only restores the temporal envelope of the original signal, but also shapes the quantization noise accordingly, which results in quantization noise, that is temporally shaped similar to the original signal. This avoids temporal unmasking of quantization noise and the pre-echo artifact common in transform audio coding. For the temporal flattening/reshaping process the application of transmitted gains as well as a low side-info companding approach are proposed. Finally the approach can also be combined with time domain aliasing reduction (TDAR) for subband merging/splitting increasing the noise shaping quality.

### BRIEF DESCRIPTION OF THE DRAWINGS

Embodiments of the present invention will be detailed subsequently referring to the appended drawings, in which:

FIG. 1 illustrates an apparatus for audio signal encoding according to an embodiment.

FIG. 2 illustrates an apparatus for audio signal decoding according to an embodiment.

FIG. 3 illustrates an system according to an embodiment.

FIG. 4 illustrates a transform audio encoder according to an embodiment, which performs temporal noise shaping on subband signals for three subband signal groups.

FIG. 5 illustrates a transform audio decoder according to an embodiment, which corresponds to the transform audio encoder of FIG. 4, and which performs temporal noise shaping on subband signals for three subband signal groups.

FIG. 6 illustrates in (a) a flattening process and in (b) a reshaping process via companding according to an embodiment.

FIG. 7 illustrates in (a) a flattening process and in (b) a reshaping process, wherein gains are to be determined at the encoder, and wherein side information is to be transmitted to the decoder.

FIG. 8 illustrates an embodiment of an encoder side for calculating and transmitting gains via AR modeling for a subband signal group.

FIG. 9 illustrates an embodiment of a decoder side for calculating and transmitting gains via AR modeling for a subband signal group, which corresponds to the encoder side depicted in FIG. 8.

FIG. 10 illustrates an embodiment of an encoder side for deriving gains for a subband signal group.

FIG. 11 illustrates an embodiment of a decoder side for deriving gains for a subband signal group, which corresponds to the encoder side depicted in FIG. 10.

FIG. 12 illustrates an embodiment of an encoder side for transmitting prototype gains via DPCM for a subband signal group.

FIG. 13 illustrates an embodiment of a decoder side for transmitting prototype gains via DPCM for a subband signal group, which corresponds to the embodiment of the encoder side depicted in FIG. 12.

FIG. 14 illustrates subband merging windows with equal lengths.

FIG. 15 illustrates subband merging windows with different lengths.

### DETAILED DESCRIPTION OF THE INVENTION

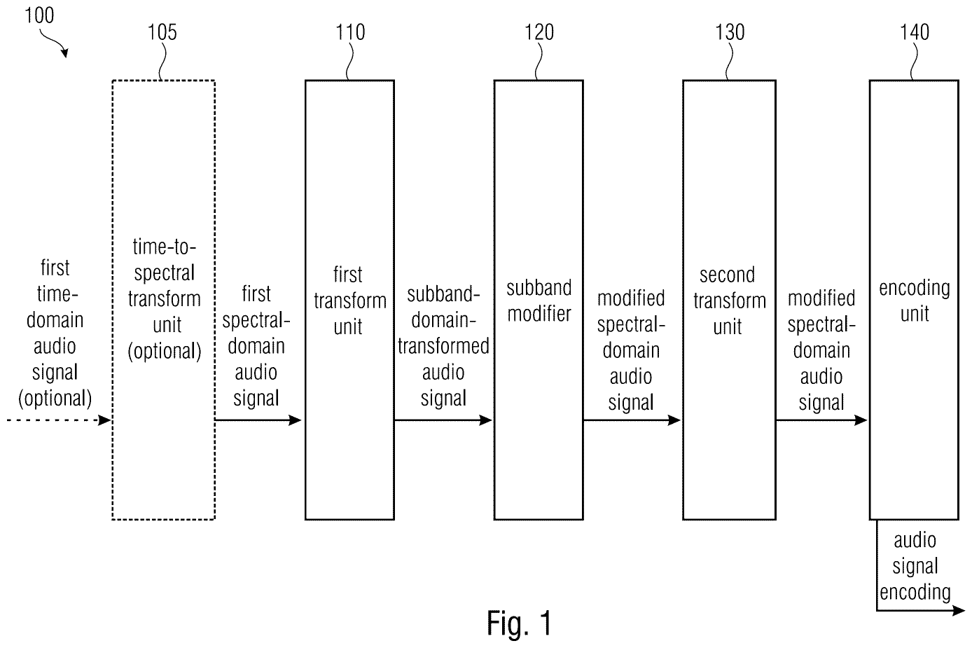

FIG. 1 illustrates an apparatus 100 for audio signal encoding according to an embodiment.

The apparatus 100 comprises a first transform unit 110 configured for transforming a first spectral-domain audio signal comprising a plurality of spectral coefficients from a spectral domain to a subband signal domain to obtain a subband-signal-domain-transformed audio signal comprising a plurality of subband signals.

Moreover, the apparatus 100 comprises a subband signal modifier 120 configured for modifying one or more subband signals of the plurality of subband signals of the subband-signal-domain-transformed audio signal to obtain a modified subband-signal-domain audio signal,

Furthermore, the apparatus 100 comprises a second transform unit 130 configured for transforming the modified subband-signal-domain audio signal from the subband signal domain to the spectral domain to obtain a modified spectral-domain audio signal, and

Moreover, the apparatus 100 comprises an encoding unit 140 configured for generating an audio signal encoding which comprises an encoding of the modified spectral-domain audio signal and modification information or an encoding thereof, wherein the modification information comprises information on how the one or more subband signals have been modified.

According to an embodiment, the subband signal modifier 120 may, e.g., be configured to modify the one or more subband signals such that a dynamic range of each of the one or more subband signals may, e.g., be reduced (e.g., flattened).

In an embodiment, the subband signal modifier 120 may, e.g., be configured to modify the one or more subband signals by modifying, depending on the modification information, a temporal envelope of each of the one or more subband signals.

According to an embodiment, the subband signal modifier 120 may, e.g., be configured to modify the temporal envelope of each of the one or more subband signals by flattening the temporal envelope of said subband signal.

In an embodiment, the subband signal modifier 120 may, e.g., be configured to modify the one or more subband signals by modifying, depending on the modification information, a temporal envelope of each of the one or more subband signals, such that a dynamic range of each of the one or more subband signals is reduced after being modified than before being modified.

According to an embodiment, the subband signal modifier 120 may, e.g., be configured to modify the one or more subband signals by modifying, depending on the modification information, a temporal envelope of each of the one or more subband signals, such that a temporal flatness measure indicates that each of the one or more subband signals is flatter after being modified than before being modified.

In an embodiment, the subband signal modifier 120 may, e.g., be configured to employ a non-linear mapping curve to reduce the dynamic range of said subband signal.

According to an embodiment, the subband signal modifier 120 may, e.g., be configured to flatten the temporal envelope of said subband signal by applying an exponent α on a magnitude of samples of the subband signal. The modification information comprises information on the exponent α and/or comprises information to determine the exponent α and/or comprises information on 1/α or comprises information to determine 1/α.

In an embodiment, the subband signal modifier 120 may, e.g., be configured to flatten the temporal envelope of said subband signal by multiplying each sample of samples of the subband signal with a gain g of a gain function. The modification information comprises information on the gain function or comprises information to determine the gain function and/or comprises information on a derived function comprising the gain 1/g for each gain g of the gain function and/or comprises information to determine the derived function.

According to an embodiment, the subband signal modifier 120 may, e.g., be configured to determine a plurality of reflection coefficients from the one or more subband signals, before being modified, depending on an autoregressive model. The encoding unit 140 may, e.g., be configured to generate the audio signal encoding, such that the audio signal encoding comprises the plurality of reflection coefficients or an encoding thereof.

In an embodiment, the subband signal modifier 120 may, e.g., be configured to generate one or more normalized spectral autocorrelation functions for the one or more subband signals before being modified. The subband signal modifier 120 may, e.g., be configured to determine the plurality of reflection coefficients for the one or more normalized spectral autocorrelation functions. The subband signal modifier 120 may, e.g., be configured to generate a plurality of gains from the plurality of reflection coefficients, and may, e.g., be configured to apply the plurality of gains on the one or more subband signals. The encoding unit 140 may, e.g., be configured to generate the audio signal encoding, such that the audio signal encoding comprises the plurality of reflection coefficients or an encoding thereof.

According to an embodiment, the subband signal modifier 120 may, e.g., be configured to determine a plurality of samples of a downsampled combined envelope for the one or more subband signals, before being modified. The subband signal modifier 120 may, e.g., be configured to determine a plurality of gains using the plurality of samples of the downsampled combined envelope depending on a modification parameter α. The subband signal modifier 120 may, e.g., be configured to modify the one or more subband signals by applying the plurality of gains on the one or more subband signals, such that, after applying the one or more gains on the one or more subband signals, a dynamic range of the one or more subband signals is reduced.

In an embodiment, the encoding unit 140 may, e.g., be configured to generate the audio signal encoding such that the audio signal encoding comprises the modification parameter α or an encoding thereof.

According to an embodiment, the subband signal modifier 120 may, e.g., be configured to determine a plurality of applicable gains for the one or more subband signals, such that by applying the plurality of applicable gains on the one or more subband signal, the dynamic range of the one or more subband signals is reduced. The encoding unit 140 may, e.g., be configured to determine a plurality of downsampled gains such that the plurality of downsampled gains represents a downsampling of the plurality of applicable gains. The encoding unit 140 may, e.g., be configured to generate the audio signal encoding such that the audio signal encoding comprises the plurality of downsampled gains or an encoding thereof.

In an embodiment, the encoding unit 140 may, e.g., be configured to generate the audio signal encoding such that the audio signal encoding comprises a Differential Pulse Code Modulation encoding of the plurality of downsampled gains.

According to an embodiment, the subband signal modifier 120 may, e.g., be configured to determine an indicator indicating a predefined mapping curve out of two or more predefined mapping curves for the one or more subband signals, before being modified. The encoding unit 140 may, e.g., be configured to generate the audio signal encoding such that the audio signal encoding comprises the indicator or an encoding thereof.

In an embodiment, the first transform unit 110 may, e.g., be configured to transform the first spectral-domain audio signal from the spectral domain to the subband signal domain by conducting a first lapped transform to obtain the subband-signal-domain-transformed audio signal comprising the plurality of subband signals. The second transform unit 130 may, e.g., be configured to transform the modified subband-signal-domain audio signal from the subband signal domain to the spectral domain by conducting a second lapped transform to obtain the modified spectral-domain audio signal.

According to an embodiment, the first transform unit 110 may, e.g., be configured to conduct the first lapped transform by transforming each block of a plurality of blocks, which comprises a portion of the plurality of spectral coefficients from the spectral domain to the subband signal domain. Each block of two or more blocks of the plurality of blocks overlaps with at least one other block of the plurality of blocks such that said block and said at least one other block comprise same spectral coefficients of the plurality of spectral coefficients.

In an embodiment, the second transform unit 130 may, e.g., be configured to conduct the second lapped transform by transforming each subband signal of the plurality of subband signals to obtain from said subband signal a plurality of intermediate samples in the spectral domain. The second transform unit 130 may, e.g., be configured to obtain a plurality of spectral coefficients of the modified spectral-domain audio signal by conducting overlap-add on the plurality of intermediate coefficients obtained from each subband signal of the plurality of subband signals.

According to an embodiment, the spectral domain may, e.g., be a Modified Discrete Cosine Transform. Or, the spectral domain may, e.g., be a Modified Discrete Sine Transform.

In an embodiment, the apparatus 100 further comprises a time-to-spectral transform unit 105 configured for transforming a first time-domain audio signal from a time domain to a spectral domain to obtain the first spectral-domain audio signal.

According to an embodiment, the subband signal modifier 120 configured may, e.g., be configured to modify the one or more subband signals by conducting a modification of a first group of one or more subband signals of the plurality of subband signals of the subband-signal-domain-transformed audio signal, and by conducting a modification of a second group of two or more subband signals of the plurality of subband signals of the subband-signal-domain-transformed audio signal, wherein the second group is different from the first group. The encoding unit 140 may, e.g., be configured to generating the audio signal encoding which comprises the modification information or an encoding thereof, such that the modification information comprises first modification information and second modification information, wherein the first modification information depends on the modification of the first group of one or more subband signals, and the second modification information depends on the modification of the second group of two or more subband signals, wherein the first modification information is different from the second modification information.

In an embodiment, the first group does not comprise any subband signals which are comprised by the second group, and wherein the second group does not comprise any subband signals which are comprised by the first group.

According to an embodiment, the first modification information comprises information on a first exponent that has been applied on samples of each subband signal of the first group of one or more subband signals. The second modification information comprises information on a second exponent that has been applied on samples of each subband signal of the second group of two or more subband signals, the second exponent being different from the first exponent.

In an embodiment, the first modification information comprises information on a first gain function that has been applied on each subband signal of the first group of one or more subband signals. The second modification information comprises information on a second gain function that has been applied on each subband signal of the second group of two or more subband signals, the second gain function being different from the first gain function.

According to an embodiment, the subband signal modifier 120 may, e.g., be configured to determine a plurality of groups of one or more subband signals depending on one or more signal characteristics of the plurality of subband signals, wherein the plurality of groups comprises the first group and the second group. The encoding unit 140 may, e.g., be configured to generate the audio signal encoding such that the audio signal encoding comprises information on how the plurality of subband signals are grouped into the plurality of groups of one or more subband signals.

In an embodiment, the subband signal modifier 120 may, e.g., be configured to determine the plurality of groups of one or more subband signals by normalizing each subband signal of the plurality of subband signals depending on the power of said subband signal to obtain a plurality of normalized subband signals, by determining a degree of similarity between the normalized subband signals, and by associating a subband signal of the plurality of subband signals to one of the plurality of groups depending on the degree of similarity between the normalized subband signal associated with said subband signal and other normalized subband signals.

According to an embodiment, the first transform unit 110 may, e.g., be configured to conduct time domain aliasing reduction for generating one or more of the plurality of subband signals using a subsequent spectrum being subsequent to a current spectrum which comprises the spectral coefficients of the first spectral-domain audio signal.

In an embodiment, the encoding unit 140 may, e.g., be configured to generate the audio signal encoding such that the audio signal encoding comprises an indication for which of the plurality of subband signals the time domain aliasing reduction has been conducted.

According to an embodiment, the first transform unit 110 may, e.g., be configured to conduct the time domain aliasing reduction for generating a subband signal of the plurality of subband signals only if a distance measure indicating a distance between the subband signal generated with conducting time domain aliasing reduction and the subband signal generated without conducting time domain aliasing reduction is greater than a threshold distance.

In an embodiment, the subband signal modifier 120 may, e.g., be configured to conduct a determination determining whether or not to modify a subband signal of the plurality of subband signals of the subband-signal-domain-transformed audio signal depending on a signal characteristics of said subband signal. The subband signal modifier 120 may, e.g., be configured to modify or to not modify said subband signal depending on the determination. The encoding unit 140 may, e.g., be configured to generate the audio signal encoding such that the audio signal encoding indicates whether or not the subband signal modifier 120 has modified said subband signal.

According to an embodiment, the subband signal modifier 120 may, e.g., be configured to conduct the determination determining whether or not to modify the subband signal by determining whether or not a transient is present in said subband signal.

In an embodiment, the subband signal modifier 120 may, e.g., be configured to employ a temporal flatness measure and/or a spectral flatness measure to determine whether or not to modify the subband signal.

According to an embodiment, the subband signal modifier 120 may, e.g., be configured to employ an autoregressive model to determine whether or not to modify the subband signal.

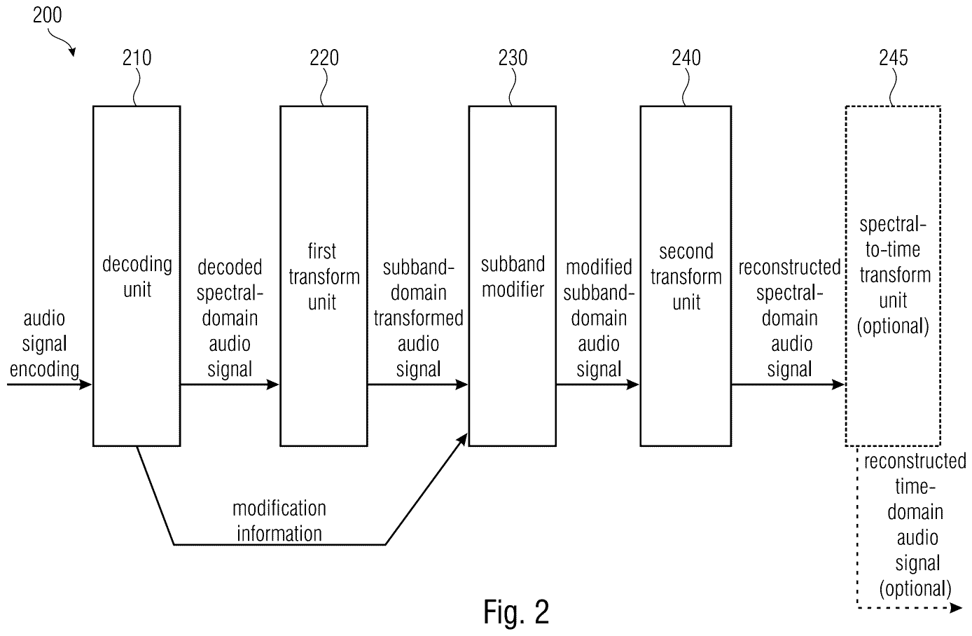

FIG. 2 illustrates an apparatus 200 for audio signal decoding according to an embodiment.

The apparatus 200 comprises a decoding unit 210 configured for decoding an audio signal encoding to obtain a decoded spectral-domain audio signal and modification information, wherein the decoded spectral-domain audio signal comprises a plurality of spectral coefficients.

Moreover, the apparatus 200 comprises a first transform unit 220 configured for transforming the decoded spectral-domain audio signal from a spectral domain to a subband signal domain to obtain a subband-signal-domain-transformed audio signal comprising a plurality of subband signals.

Furthermore, the apparatus 200 comprises a subband signal modifier 230 configured for obtaining a modified subband-signal-domain audio signal by modifying, depending on the modification information, one or more subband signals of the plurality of subband signals of the subband-signal-domain-transformed audio signal.

Moreover, the apparatus 200 comprises a second transform unit 240 configured for transforming the modified subband-signal-domain audio signal from the subband signal domain to the spectral domain to obtain a reconstructed spectral-domain audio signal.

According to an embodiment, the subband signal modifier 230 may, e.g., be configured to modify the one or more subband signals such that a dynamic range of each of the one or more subband signals is increased (e.g., reshaped).

In an embodiment, the subband signal modifier 230 may, e.g., be configured to modify the one or more subband signals by modifying, depending on the modification information, a temporal envelope of each of the one or more subband signals.

According to an embodiment, the subband signal modifier 230 may, e.g., be configured to modify the temporal envelope of each of the one or more subband signals by reshaping (e.g., unflattening/reconstructing) the temporal envelope of said subband signal.

In an embodiment, the subband signal modifier 230 may, e.g., be configured to modify the one or more subband signals by modifying, depending on the modification information, a temporal envelope of each of the one or more subband signals, such that a dynamic range of each of the one or more subband signals is increased after being modified than before being modified.

According to an embodiment, the subband signal modifier 230 may, e.g., be configured to modify the one or more subband signals by modifying, depending on the modification information, a temporal envelope of each of the one or more subband signals, such that a temporal flatness measure indicates that each of the one or more subband signals is flatter before being modified than after being modified.

In an embodiment, the subband signal modifier 230 may, e.g., be configured to employ a non-linear mapping curve to increase the dynamic range of said subband signal.

According to an embodiment, the modification information comprises information on an exponent α or information to determine the exponent α. The subband signal modifier 230 may, e.g., be configured to reshape (e.g., unflatten/reconstruct) the temporal envelope of said subband signal by applying an exponent β on a magnitude of samples of the subband signal, wherein β=α, and/or wherein β=1/α, and/or wherein β is derived from α.

In an embodiment, the modification information comprises information on a received gain function or information to determine the received gain function. The subband signal modifier 230 may, e.g., be configured to reshape (e.g., unflatten/reconstruct) the temporal envelope of said subband signal
by multiplying each sample of samples of the subband signal with a gain g of an applied gain function, or
by multiplying each sample of the samples of the subband signal with 1/g, wherein g is a gain of an applied gain function.

The applied gain function may, e.g., be equal to the received gain function, or the applied gain function may, e.g., be derived from the gain function.

According to an embodiment, the decoding unit 210 may, e.g., be configured to obtain a plurality of reflection coefficients from the audio signal encoding. The subband signal modifier 230 may, e.g., be configured to modify, depending on an autoregressive model, the one or more subband signals depending on the plurality of reflection coefficients.

In an embodiment, the plurality of reflection coefficients are a plurality of reflection coefficients for one or more normalized spectral autocorrelation functions. The subband signal modifier 230 may, e.g., be configured to generate a plurality of gains from the plurality of reflection coefficients. The subband signal modifier 230 may, e.g., be configured to modify the one or more subband signals depending on the plurality of gains.

According to an embodiment, the subband signal modifier 230 may, e.g., be configured to determine a plurality of samples of a downsampled combined envelope for the one or more subband signals, before being modified. The subband signal modifier 230 may, e.g., be configured to determine a plurality of gains using the plurality of samples of the downsampled combined envelope depending on a modification parameter α. The subband signal modifier 230 may, e.g., be configured to modify the one or more subband signals by applying the plurality of gains on the one or more subband signals, such that, after applying the one or more gains on the one or more subband signals, a dynamic range of the one or more subband signals is increased.

In an embodiment, the decoding unit 210 may, e.g., be configured to obtain the modification parameter α from the audio signal encoding.

According to an embodiment, the decoding unit 210 may, e.g., be configured to obtain plurality of downsampled gains from the audio signal encoding. The decoding unit 210 may, e.g., be configured to obtain a plurality of applicable gains from the plurality of downsampled gains, such that the plurality of applicable gains represents an upsampling of the plurality of downsampled gains. The subband signal modifier 230 may, e.g., be configured to modify the one or more subband signals by applying the plurality of applicable gains on the one or more subband signals, such that the dynamic range of the one or more subband signals is increased.

In an embodiment, the audio signal encoding comprises a Differential Pulse Code Modulation encoding of the plurality of downsampled gains. The decoding unit 210 may, e.g., be configured to obtain the plurality of downsampled gains from the Differential Pulse Code Modulation encoding of the plurality of downsampled gains within the audio signal encoding.

According to an embodiment, the decoding unit 210 may, e.g., be configured to obtain an indicator indicating a predefined mapping curve out of two or more predefined mapping curves. The subband signal modifier 230 may, e.g., be configured to obtain said predefined mapping curve. The subband signal modifier 230 may, e.g., be configured to modify, depending on said predefined mapping curve, the one or more subband signals.

In an embodiment, the first transform unit 220 may, e.g., be configured to transform the decoded spectral-domain audio signal from the spectral domain to the subband signal domain by conducting a first lapped transform to obtain the subband-signal-domain-transformed audio signal comprising the plurality of subband signals. The second transform unit 240 may, e.g., be configured to transform the modified subband-signal-domain audio signal from the subband signal domain to the spectral domain by conducting a second lapped transform to obtain the reconstructed spectral-domain audio signal.

According to an embodiment, the first transform unit 220 may, e.g., be configured to conduct the first lapped transform by transforming each block of a plurality of blocks, which comprises a portion of the plurality of spectral coefficients from the spectral domain to the subband signal domain. Each block of two or more blocks of the plurality of blocks overlaps with at least one other block of the plurality of blocks such that said block and said at least one other block comprise same spectral coefficients of the plurality of spectral coefficients.

In an embodiment, the second transform unit 240 may, e.g., be configured to conduct the second lapped transform by transforming each subband signal of the plurality of subband signals to obtain from said subband signal a plurality of intermediate samples in the spectral domain. The second transform unit 240 may, e.g., be configured to obtain a plurality of spectral coefficients of the reconstructed spectral-domain audio signal by conducting overlap-add on the plurality of intermediate coefficients obtained from each subband signal of the plurality of subband signals.

According to an embodiment, the spectral domain may, e.g., be a Modified Discrete Cosine Transform. Or, the spectral domain may, e.g., be a Modified Discrete Sine Transform.

In an embodiment, the apparatus 200 further comprises a spectral-to-time transform unit 245 configured for transforming the reconstructed spectral-domain audio signal from the spectral domain to a time domain to obtain a reconstructed time-domain audio signal.

According to an embodiment, the modification information comprises first modification information and second modification information, wherein the first modification information is different from the first modification information. The subband signal modifier 230 configured may, e.g., be configured to modify the one or more subband signals by conducting a modification of a first group of one or more subband signals of the plurality of subband signals of the subband-signal-domain-transformed audio signal according depending on the first modification information, and by conducting a modification of a second group of two or more subband signals of the plurality of subband signals of the subband-signal-domain-transformed audio signal depending on the second modification information, wherein the second group is different from the first group.

In an embodiment, the first group does not comprise any subband signals which are comprised by the second group, and wherein the second group does not comprise any subband signals which are comprised by the first group.

According to an embodiment, the first modification information comprises a received first exponent, wherein the second modification information comprises a received second exponent. The subband signal modifier 230 configured may, e.g., be configured to apply the received first exponent or a first value derived from the received first exponent on samples of the first group of one or more subband signals of the plurality of subband signals. The subband signal modifier 230 configured may, e.g., be configured to apply the received second exponent or a second value derived from the received second exponent on samples of the second group of two or more subband signals of the plurality of subband signals.

In an embodiment, the first modification information comprises a received first gain function, wherein the second modification information comprises a received second gain function. The subband signal modifier 230 configured may, e.g., be configured to apply the received first gain function or a derived first gain function derived from the received first gain function on each subband signal of the first group of one or more subband signals. The subband signal modifier 230 configured may, e.g., be configured to apply the received second gain function or a derived second gain function derived from the received second gain function on each subband signal of the second group of two or more subband signals.

According to an embodiment, the audio signal encoding comprises information on how the plurality of subband signals are grouped into a plurality of groups of one or more subband signals, wherein the plurality of groups comprises the first group and the second group.

In an embodiment, when transforming the plurality of subband signal to the spectral domain, the second transform unit 240 may, e.g., be configured to undo a time domain aliasing reduction operation conducted on an encoder side.

According to an embodiment, the audio signal encoding comprises an indication for which of the plurality of subband signals time domain aliasing reduction has been conducted, and when transforming the plurality of subband signal to the spectral domain, the second transform unit 240 may, e.g., be configured to undo the time domain aliasing reduction operation for those subband signals which are indicated by the indication.

In an embodiment, the audio signal encoding comprises a modification indication indicating whether or not a subband signal of the plurality of subband signals has been modified on an encoder side. The subband signal modifier 230 may, e.g., be configured to modify or to not modify said subband signal depending on the modification indication.

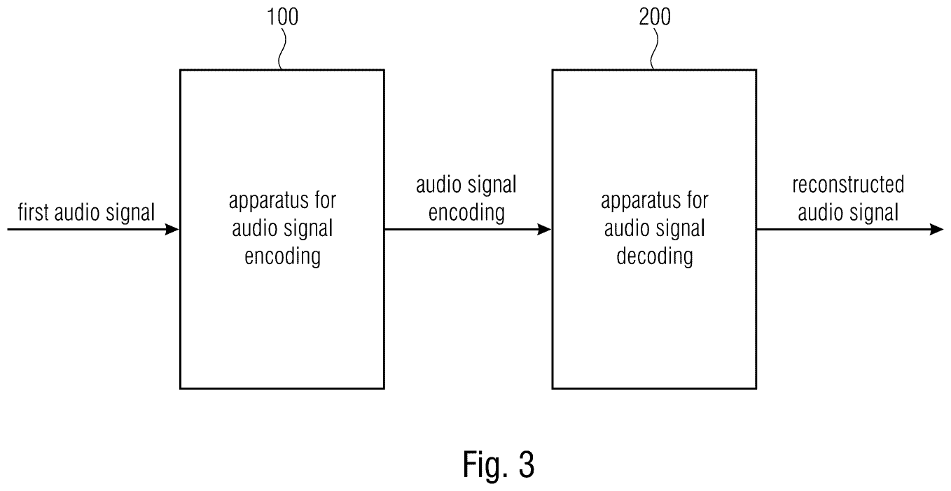

FIG. 3 illustrates a system according to an embodiment.

The system comprises an apparatus 100 for audio signal encoding according to FIG. 1 and an apparatus 200 for audio signal decoding according to FIG. 2.

The apparatus 200 for audio signal decoding is configured to receive the audio signal encoding being generated by the apparatus 100 for audio signal encoding.

In the following, concepts on which embodiments of the present invention are based are described.

In the following, MDCT and Subband Merging/Splitting is described.

Subband Merging/Splitting as introduced in [6] is a method for building non-uniform filterbanks based on the MDCT and a short summary is given here. The method builds on the MDCT that is given for input signal frames

$${x}_{i} [ n ] = {w}_{t} [ n ] \cdot x [ n + i \cdot M ] with 0 \leq n < 2 M \qquad ( 1 )$$

$$as$$

$${X}_{i} [ k ] = \sqrt{\frac{2}{M}} {\sum }_{n = 0}^{2 M - 1} {x}_{i} [ n ] \cdot κ [ k , n , M ] with 0 \leq k < M \qquad ( 2 )$$

where wₜ[n] is a suitable window function.

In contrast to [6] we use the more common positive time shift

$${n}_{0} = \frac{M}{2} + \frac{1}{2}$$

$$κ [ k , n , M ] = cos [ \frac{π}{M} ( k + \frac{1}{2} ) ( n + {n}_{0} ) ] \qquad ( 3 )$$

here. Nevertheless, also the kernel

$${n}_{0} = \frac{M}{2} + \frac{1}{2}$$

can be used, when accounting for the time-reversed subband signals compared to the positive time-shift kernel.

For subband merging the MDCT spectrum is segmented into subbands of widths 2N_{ν}, where ν is the subband index. In order to maintain a concise notation a common subband width 2N_{ν}=2N is chosen, though it has to be noted, that every valid MDCT window switching sequence [1] is applicable in practice.

The subband signals can then be obtained via subband merging as

$${X}_{ν , i} [ k ] = {w}_{f} [ k ] \cdot {X}_{i} [ k + ν \cdot N ] with 0 \leq k < 2 N \qquad ( 4 )$$

$${\hat{x}}_{ν , i} [ m ] = \sqrt{\frac{2}{N}} {\sum }_{k = 0}^{2 N - 1} {X}_{ν , i} [ k ] \cdot κ [ m , k , N ] with 0 \leq m < N \qquad ( 5 )$$

where w_{f}[n] is a suitable window function. It has to be noted that in this step, frequency domain aliasing is introduced.

From the subband signals the MDCT spectrum can be reconstructed via subband splitting to

$${\hat{X}}_{ν , i} [ k ] = \sqrt{\frac{2}{N}} {\sum }_{m = 0}^{N - 1} {\hat{x}}_{ν , i} [ m ] \cdot κ [ m , k , N ] with 0 \leq k < 2 N \qquad ( 6 )$$

followed by the spectral overlap-add process

$${X}_{ν , i} [ k ] = {w}_{f} [ k + N ] \cdot {\hat{X}}_{ν - 1 , i} [ k + N ] + {w}_{f} [ k ] \cdot {\hat{X}}_{ν , i} [ k ] \qquad ( 7 )$$

$${X}_{i} [ k + ν N ] = {X}_{ν , i} [ k ] . \qquad ( 8 )$$

For reconstructing the time domain signal this is followed by Inverse Modified Discrete Cosine Transform (IMDCT)

$${\hat{x}}_{i} [ n ] = \sqrt{\frac{2}{M}} {\sum }_{k = 0}^{M - 1} {X}_{i} [ k ] \cdot κ [ k , n , M ] with 0 \leq k < 2 M \qquad ( 9 )$$

and the temporal overlap-add process

$${x}_{i} [ n ] = {w}_{t} [ n + M ] \cdot {\hat{x}}_{i - 1} [ n + M ] + {w}_{t} [ n ] \cdot {\hat{x}}_{i} [ n ] \qquad ( 10 )$$

$$x [ n + iM ] = {x}_{i} [ k ] . \qquad ( 11 )$$

Note that for simplicity temporal/spectral analysis and synthesis windows were chosen to wₜ[n]/w_{f}[n] and constant over i/v. However, in general synthesis and analysis windows can be different as well as depending on i/v as long as the Princen Bradley condition [7] is fulfilled.

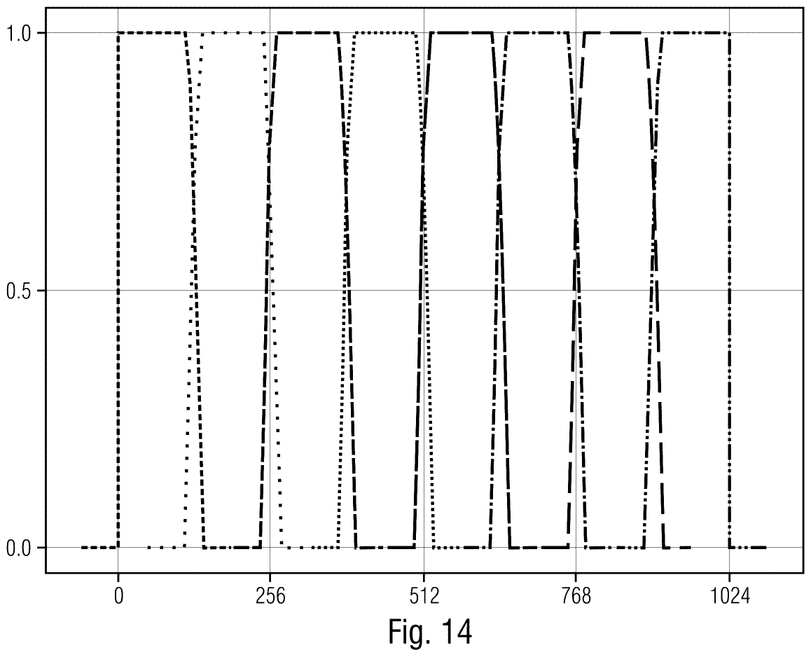

To illustrate a first example for subband merging, FIG. 14 illustrates subband merging windows with equal lengths.

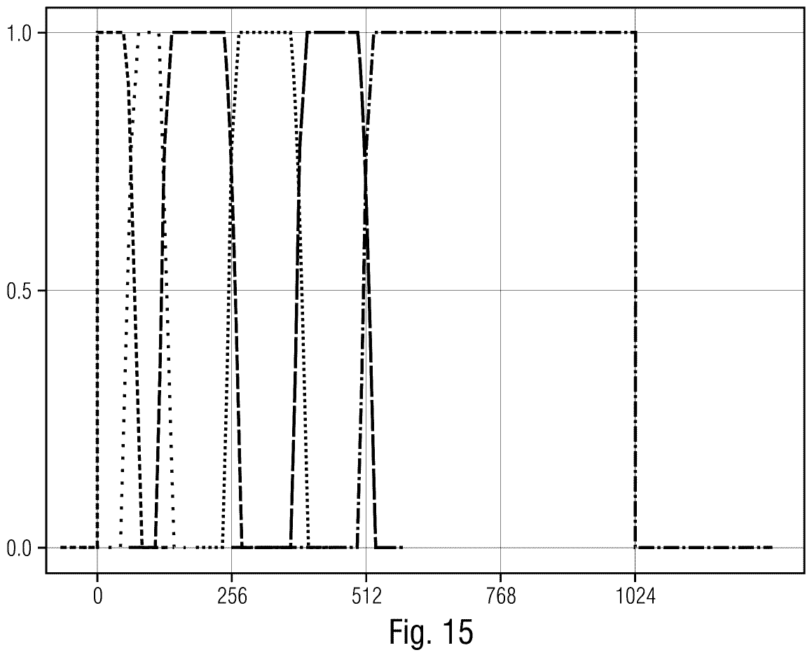

To illustrate another example for subband merging, FIG. 15 illustrates subband merging windows with different lengths.

In the following, a new approach for temporal noise shaping based on subband merging/splitting [6] of the MDCT spectrum is provided. This allows for a modification of the temporal envelope of MDCT subband signals in a way that results in a flattened envelope in the encoder before quantization and a reshaped envelope including the quantization noise in the decoder. While the method is comparable to well-known gain control, it does not require an auxiliary filterbank, but works entirely in the MDCT domain like TNS [5] based on LPC. Compared to LPC based TNS the new method allows for much more flexibility regarding how the temporal flattening/reshaping is performed.

At first, the foundation for MDCT and subband merging/splitting is introduced. Then temporal noise shaping using flattening and reshaping on subband signals is explained and two approaches for doing so are proposed including different methods for coding side information. This is followed by the explanation of how TDAR can be used in this scheme. Finally exemplary detection algorithms are provided.

Now, particular embodiments of the present invention are described.

In particular, new concepts for TNS on Subband Signals, more particularly, for TNS based on subband merging/splitting are now introduced.

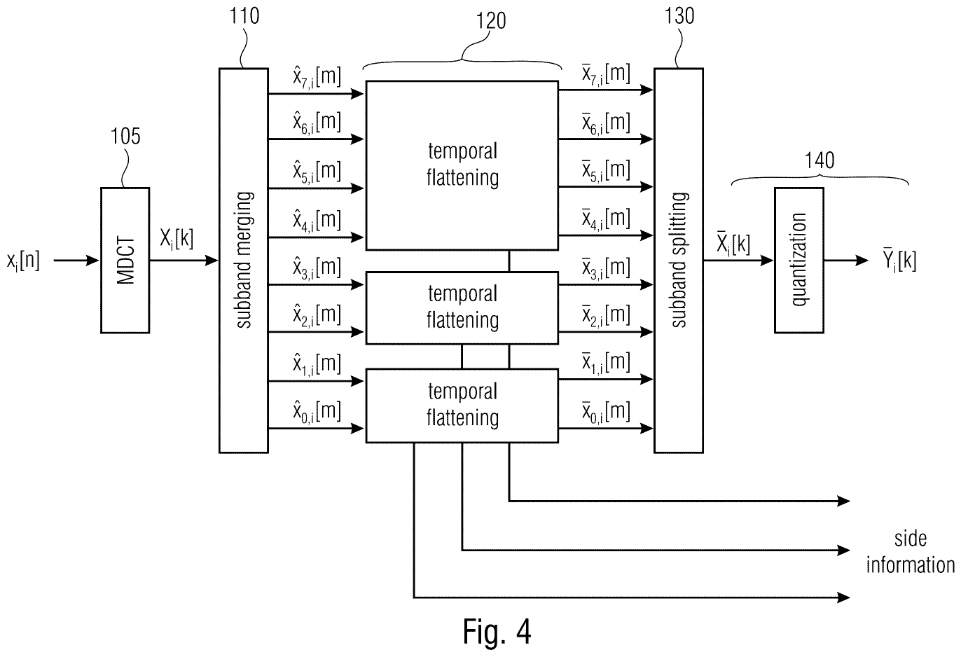

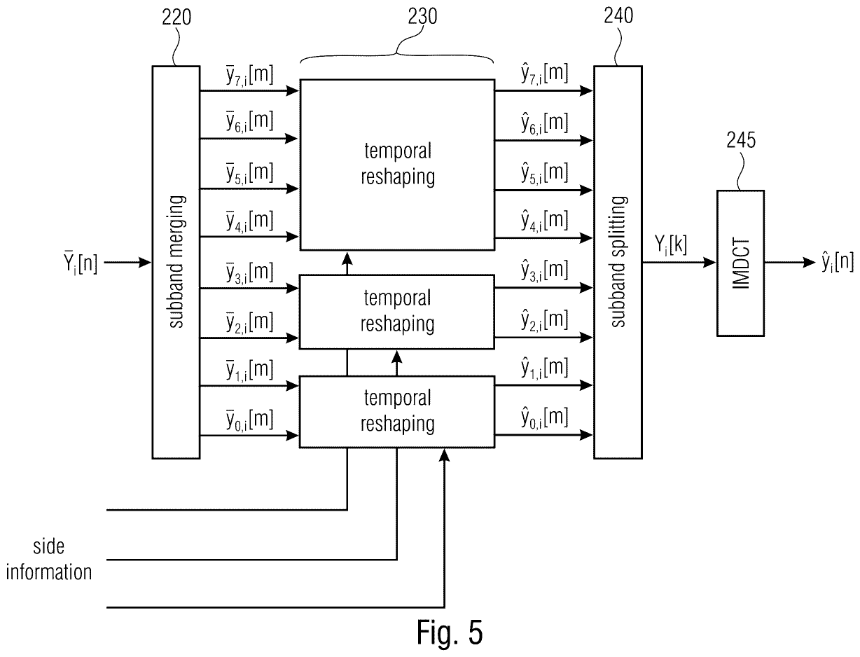

The basic concept of some of the embodiments is depicted in FIG. 4 and FIG. 5

FIG. 4 illustrates a (simplified) transform audio encoder, which performs temporal noise shaping on subband signals for P=3 subband signal groups Ψ₀={0, 1}. Ψ₁={2, 3} and Ψ₂={4, 5, 6, 7}.

Analogously, FIG. 5 illustrates a (simplified) transform audio decoder, which corresponds to the transform audio encoder of FIG. 4, and which performs temporal noise shaping on subband signals for P=3 subband signal groups Ψ₀={0,1}, Ψ₁={2, 3} and Ψ₂={4, 5, 6, 7}.

In the encoder, the MDCT is transformed into the subband signals x_{v,i}[m] The subband signal indices ν are grouped into P sets Ψ_{ψ} with 0≤ψ<P and

$${⋂}_{ψ = 0}^{P - 1} {Ψ}_{ψ} = ∅ .$$

Even though in the presentation above, the sets Ψ_{ψ} contain only the subband signal indices and not the subband signals themselves, when reference is made to the term “subband signal group” it is understood that a subband signal group may, e.g., comprise one or more subband signals. Nonetheless, for better readability of the explanations provided here, subband signal sets Ψ_{ψ}, comprising a plurality of indices with identify the subband signals of the group are used in the explanations provided here. Some embodiments may, e.g., use such subband signal sets, e.g., to identify the subband signals.

For all subband signals in one group, a common temporal flattening operation is performed on the respective subband signal and side information is transmitted to the decoder. This is followed by the reconstruction of the MDCT spectrum via subband splitting and quantization, which is usually controlled by a perceptual model.

In the decoder subband merging is performed to obtain the quantized, flattened subband signals ÿ_{ν,i}[m]. Then, for all subband signals in a subband signal group based on the side information a common temporal reshaping process is performed, which restores the original temporal envelope of the signal and thereby also shapes the quantization noise accordingly. Again the MDCT spectrum is reconstructed via subband splitting and transformed back in the time domain.

If the reshaping operation is the inverse to the flattening operation, the entire processing is perfectly reconstructing in the absence of quantization, even though this is not a required constraint in order for the method to work.

In general the grouping of subband signals can be chosen adaptively for each frame and transmitted as side information. However in the following, we will consider it to be constant.

Also it can be beneficial to never apply any processing to a certain subband signal group and therefore not transmit any side information for that group. This is especially useful for the subband signals corresponding to very low frequencies, as these are less prone to pre-echo artifacts and therefore do not require temporal noise shaping.

In the following, flattening/reshaping via companding is described.

A simple way to perform flattening/reshaping of the subband signals, is to apply companding as known from Pulse Code Modulation (PCM) coding. The flattening and reshaping is then realized via non-linear mapping curve for compression and expansion respectively. Similar approaches have been successfully applied to spectral [8] and temporal noise shaping [4].

Theoretically, any suitable invertible function c(·) could be used for compression and consequently c⁻¹(·) for expansion. Here an exponential function c(·)=sign (·)·|·|^{α} is chosen, as it can be parametrized easily via the exponent: α∈[0; 1].

The flattened subband signals in group Ψ_{ψ} in the encoder

$${\overline{x}}_{ν , i} [ m ] = sign ( {\hat{x}}_{ν , i} [ m ] ) \cdot {\vert {\hat{x}}_{ν , i} [ m ] \vert}^{{α}_{ψ , i}} ∀ ν ∈ {Ψ}_{ψ} \qquad ( 12 )$$

are obtained via compression. At the decoder we apply the inverse function for expansion to obtain

$${\hat{y}}_{ν , i} [ m ] = sign ( {\overline{y}}_{ν , i} [ m ] ) \cdot {\vert {\overline{y}}_{ν , i} [ m ] \vert}^{1 / {α}_{ψ , i}} ∀ ν ∈ {Ψ}_{ψ} \qquad ( 13 )$$

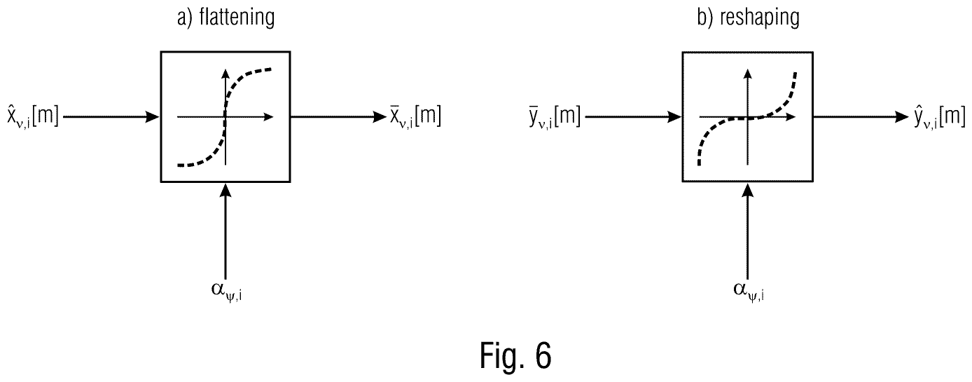

the reshaped subband signals. The flattening/reshaping process via companding is depicted in FIG. 6.

FIG. 6 illustrates in (a) a flattening process and in (b) a reshaping process via companding for subband signal index ν in subband signal group set Ψ_{ψ} according to an embodiment. The parameter α_{ψ,i} controlling the shape of the companding function has to be determined at the encoder and transmitted to the decoder as side information.

The exponent α_{ψ,i} should be chosen adaptively depending on the temporal characteristic of the subband signals in group Ψ_{ψ}. For non-transient signals α_{ψ,i} should be chosen to 1, which effectively switches off companding. The stronger transient signals are, the closer to 0 a value for α_{ψ,i} should be chosen, which results in stronger companding.

Furthermore, α_{ψ,i} has to be transmitted to the decoder. An example could be to use 2 bit to transmit to be able to transmit one of the values 0.3, 0.4, 0.5 and 1.0, where the last value results in companding being switched off.

In the following, flattening/reshaping via gains is described.

An alternative way to perform flattening/reshaping of the subband signals, is via the multiplication with a gain envelope.

At the encoder the temporal flattening is carried out via multiplicative application of gains f_{ψ,i}[in]>0 leading to

$${\overline{x}}_{ν , i} [ m ] = {\hat{x}}_{ν , i} [ m ] \cdot {f}_{ψ , i} [ m ] ∀ ν ∈ {Ψ}_{ψ} \qquad ( 14 )$$

to obtain the flattened subband signals in group Ψ_{ψ}.

Then, at the decoder

$${\hat{y}}_{ν , i} [ m ] = {\overline{y}}_{ν , i} [ m ] \cdot {g}_{ψ , i} [ m ] ∀ ν ∈ {Ψ}_{ψ} \qquad ( 15 )$$

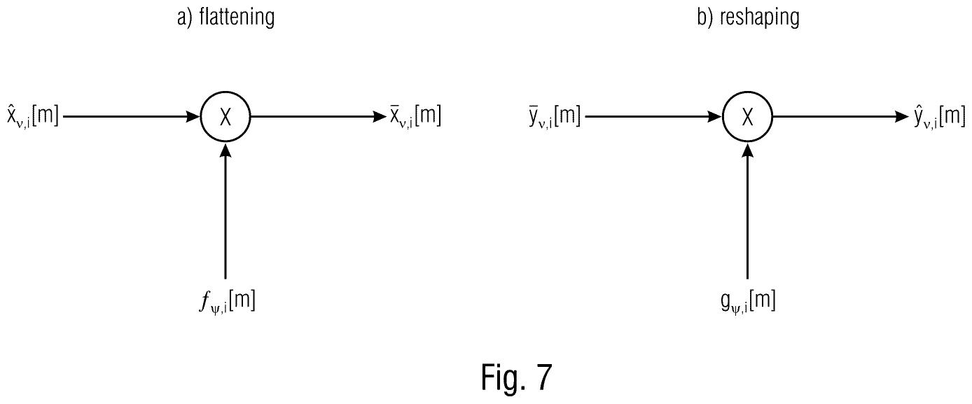

is performed for the subband signal temporal envelopes with the reshaping gains g_{ψ,i}[m]>0. The flattening/reshaping process via gains is visualized in FIG. 7.

FIG. 7 illustrates in (a) a flattening process and in (b) a reshaping process for subband signal index ν in subband signal group set Ψ_{ψ} wherein the gains f_{ψ,i}[m] and g_{ψ,i}[m] are to be determined at the encoder, and wherein g_{ψ,i}[m] is to be transmitted to the decoder as side information.

In the following, the transmission of gains according to embodiments is described.

In the following, several exemplary methods for calculating f_{ψ,i}[m] and transmitting/obtaining the gains g_{ψ,i}[m] to/at the decoder are proposed. Depending on the method also the process and the result of determining the encoder side gains f_{ψ,i}[m] may differ. It has to be noted that only a very basic way of calculating f_{ψ,i}[m] and g_{ψ,i}[m] for each method is presented here. Other ways are also possible.

In the following, coding the gains by employing an autoregressive model is described.

Coding the gains using an AR model is very close to the way side info is transmitted in the well-known LPC based TNS method [5]. The normalized spectral Autocorrelation Function (ACF) required for obtaining the AR model coefficients for subband signal group Ψ_{ψ} can be calculated as

$${r}_{ψ , i} [ τ ] = {\sum }_{ν ∈ {Ψ}_{ψ}} \frac{1}{{\sum }_{k = 0}^{2 N - 1} {X}_{ν , i}^{2} [ k ]} {\sum }_{k = 0}^{2 N - 1 - τ} {X}_{ν , i} [ k ] \cdot {X}_{ν , i} [ k + τ ] \qquad ( 16 )$$

containing the sum of the normalized spectral ACFs of the corresponding subband signals. This makes sure that the temporal shaping is not dominated by high-energy subband signals. It has to be noted that also the aliased spectrum \hat{X}_{v,i}[k] could be used for the calculation of the spectral ACFs for each subband.

Just as for LPC based TNS, the Levinson-Durbin algorithm [9] can be used to convert the ACF to RCs for each subband signal group. For this process an AR model order can be chosen, resulting in as many RCs. The RCs can be quantized

and entropy coded as done in LPC based TNS methods like in AAC [10], EVS or LC3 and transmitted to the decoder. At encoder and decoder the quantized reflection coefficients are converted back to the linear prediction filter coefficients A_{ψ,i}[k] of length model order +1. This conversion is sometimes also referred to as “rc2poly”.

In an embodiment, the encoder sided gains can then be calculated via Inverse Generalized Discrete Fourier Transform (IGDFT)

$${a}_{ψ , i} [ m ] = {\sum }_{k = 0}^{model \_ order} {A}_{ψ , i} [ k ] \cdot exp [ j \frac{2 π}{2 N} ( k + \frac{1}{2} ) ( n + \frac{1}{2} ) ] \qquad ( 17 )$$

$$and$$

$${f}_{ψ , i} [ m ] = \vert {a}_{ψ , i} [ m ] \vert . \qquad ( 18 )$$

In a further embodiment, the encoder sided gains can then be calculated via Inverse Generalized Discrete Fourier Transform (IGDFT)

$${a}_{ψ , i} [ m ] = {\sum }_{k = 0}^{model \_ order} {A}_{ψ , i} [ k ] \cdot exp [ j \frac{2 π}{2 N} ( k + \frac{1}{2} ) ( m + \frac{1}{2} ) ] \qquad ( {17}^{′} )$$

$$and$$

$${f}_{ψ , i} [ m ] = \vert {a}_{ψ , i} [ m ] \vert . \qquad ( 18 )$$

In another embodiment, the encoder sided gains can then be calculated via Inverse Generalized Discrete Fourier Transform (IGDFT)

$${a}_{ψ , i} [ m ] = {\sum }_{k = 0}^{model \_ order + 1} {A}_{ψ , i} [ k ] \cdot exp [ j \frac{2 π}{2 N} ( k + \frac{1}{2} ) ( m + \frac{1}{2} ) ] \qquad ( 17 - 1 )$$

$$and$$

$${f}_{ψ , i} [ m ] = \vert {a}_{ψ , i} [ m ] \vert . \qquad ( 18 )$$

Depending on the entire coding system a further normalization of f_{ψ,i}[m] via a multiplicative scaling might be required. For example normalizing f_{ψ,i}[m] to a Root Mean Square (RMS) value of 1 is convenient to avoid unnecessary scaling of subband signals.

The decoder sided gains are simply given as the inverse

$${g}_{ψ , i} [ m ] = {f}_{ψ , i}^{- 1} [ m ] . \qquad ( 19 )$$

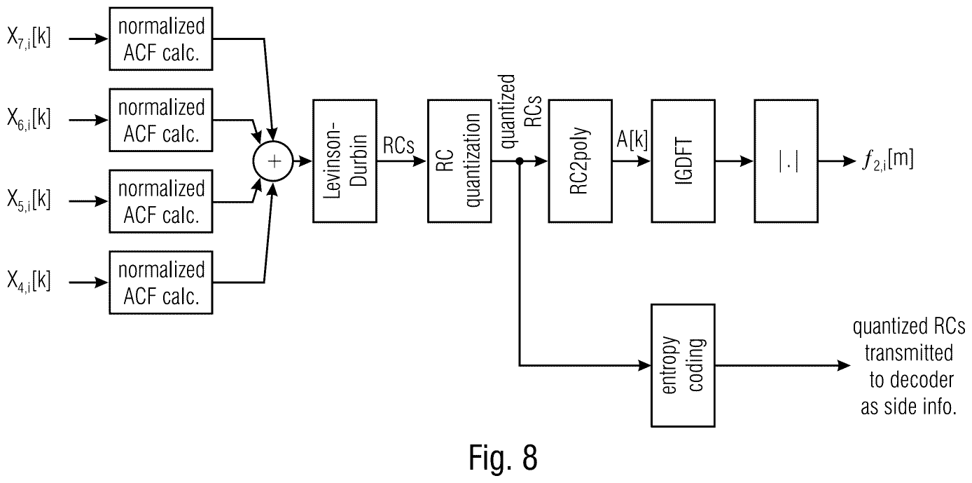

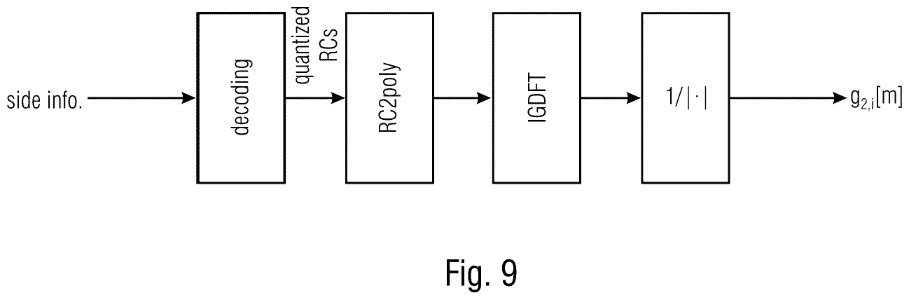

The encoder and decoder side processing is visualized in FIG. 8 and FIG. 9.

FIG. 8 illustrates an embodiment of an encoder side for calculating and transmitting gains via AR modeling for the subband signal group Ψ₂ defined with respect to FIG. 4 and FIG. 5.

FIG. 9 illustrates an embodiment of a decoder side for calculating and transmitting gains via AR modeling for the subband signal group Ψ₂ defined with respect to FIG. 4 and FIG. 5, which corresponds to the encoder side depicted in FIG. 8.

In the following, a concept is described, in which derived gains are coded.

The companding-based concept presented above can be extended to a concept, where the reshaping gains g_{ψ,i}[m] are not transmitted explicitly, but derived from the subband signals using transmitted side info.

First, in an embodiment, a downsampled combined envelope of for each subband signal group is calculated, e.g., via

$${e}_{ψ , i} [ l ] = \sqrt{{\sum }_{v ∈ {ψ}_{ψ}} {\sum }_{m = l \cdot D}^{( l + 1 ) \cdot D - 1} {\hat{x}}_{v , i}^{2} [ m ]} with 0 \leq l < L \qquad ( 20 )$$

where D=N/L is an integer downsampling factor and therefore should be chosen in a way that N mod L=0.

In another embodiment, a downsampled combined envelope of for each subband signal group is calculated, e.g., via

$${e}_{ψ , i} [ l ] = \sqrt{{\sum }_{v ∈ {ψ}_{ψ}} {\sum }_{m = l \cdot D}^{( l + 1 ) \cdot D - 1} {\hat{x}}_{v , i}^{2} [ m ]} with 0 \leq l < L . \qquad ( 20 - 1 )$$

where D=N/L is an integer downsampling factor and therefore should be chosen in a way that N mod L=0.

In the encoder the gains are obtained via exponential compression of the downsampled subband signaled envelope

$${f}_{ψ , i} [ m ] = {( {e}_{ψ , i} [ ⌊ m / D ⌋ ] )}^{{α}_{ν , i} - 1} \qquad ( 21 )$$

in a straightforward way. The parameter α_{ψ,i} determines the strength of the companding effect and is transmitted as side information in the same way as explained above.

In an embodiment, at the decoder, we obtain the gains as an approximation of the encoder sided gains as

$${\tilde{e}}_{ψ , i} [ l ] = \sqrt{{\sum }_{v ∈ {ψ}_{ψ}} {\sum }_{m = l \cdot D}^{( l + 1 ) \cdot D - 1} {\overline{y}}_{v , i}^{2} [ m ]} with 0 \leq l < L \qquad ( 22 )$$

$${g}_{ψ , i} [ m ] = {( {\tilde{e}}_{ψ , i} [ ⌊ m / D ⌋ ] )}^{\frac{1 - {α}_{ν , i}}{{α}_{ν , i}}} . \qquad ( 23 )$$

In another embodiment, at the decoder, we obtain the gains as an approximation of the encoder sided gains as

$${\tilde{e}}_{ψ , i} [ l ] = \sqrt{{\sum }_{v ∈ {ψ}_{ψ}} {\sum }_{m = l \cdot D}^{( l + 1 ) \cdot D - 1} {\overline{y}}_{v , i}^{2} [ m ]} with 0 \leq l < L \qquad ( 22 - 1 )$$

$${g}_{ψ , i} [ m ] = {( {\tilde{e}}_{ψ , i} [ ⌊ m / D ⌋ ] )}^{\frac{1 - {α}_{ν , i}}{{α}_{ν , i}}} . \qquad ( 23 )$$

It may be noted that, if the downsampling factor is chosen to D=1 and the number of subband signals in set |Ψ_{ψ}|=1, this method leads to the exact same result as the temporal flattening/reshaping based on companding, as described above.

Note that the calculation of e_{ψ,i}[l] and \tilde{e}_{ψ,i}[l] could additionally incorporate a multiplicative normalization factor depending to avoid unnecessary scaling of the subband signals.

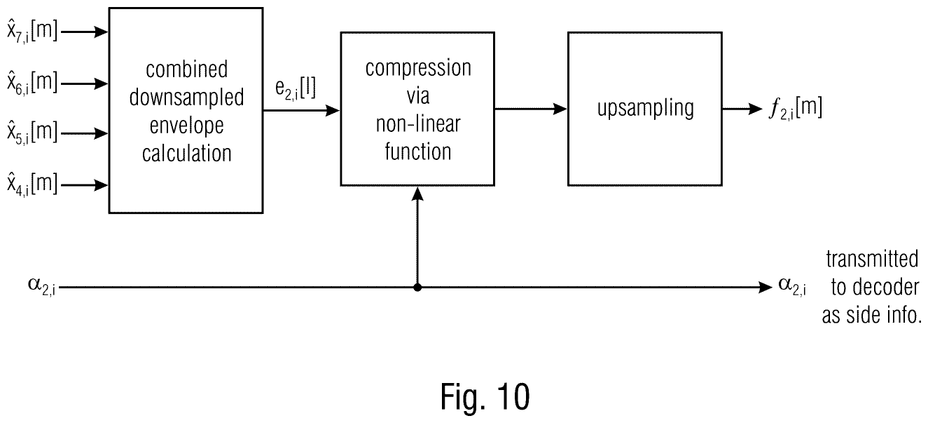

FIG. 10 illustrates an embodiment of an encoder side for deriving gains for the subband signal group Ψ₂ defined with respect to FIG. 4 and FIG. 5.

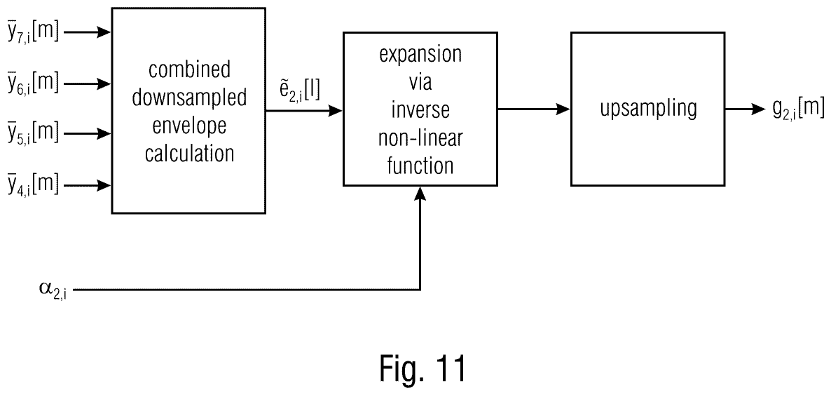

FIG. 11 illustrates an embodiment of a decoder side for deriving gains for the subband signal group Ψ₂ defined with respect to FIG. 4 and FIG. 5, which corresponds to the encoder side depicted in FIG. 10

In the following, coding the gains using DPCM coding is described.

Transmitting the gains via Differential Pulse Code Modulation (DPCM) coding allows for high flexibility in the determination of the gains, which helps achieving temporal noise shaping with more consideration of perceptual effects. However, this method might be less efficient in terms of side information overhead. The basic idea follows a “scale factor” approach as often done for frequency domain noise shaping [10], but in the subband signal time domain for temporal noise shaping.

In an embodiment, for each subband signal group Ψ_{ψ}, downsampled prototype gains \tilde{g}_{ψ,i}[l] are calculated, e.g., by simply setting

$${\tilde{g}}_{ψ , i} [ l ] = \sqrt{{\sum }_{v ∈ {ψ}_{ψ}} {\sum }_{m = l \cdot D}^{( l + 1 ) \cdot D - 1} {\hat{x}}_{v , i}^{2} [ m ]} with 0 \leq l < L \qquad ( 24 )$$

where D=N/L is an integer downsampling factor and therefore should be chosen in a way that N mod L=0.

In another embodiment, for each subband signal group Ψ_{ψ}, downsampled prototype gains \tilde{g}_{ψ,i}[l] are calculated, e.g., by simply setting

$${\tilde{g}}_{ψ , i} [ l ] = \sqrt{{\sum }_{v ∈ {ψ}_{ψ}} {\sum }_{m = l \cdot D}^{( l + 1 ) \cdot D - 1} {\hat{x}}_{v , i}^{2} [ m ]} with 0 \leq l < L \qquad ( 24 - 1 )$$

where D=N/L is an integer downsampling factor and therefore should be chosen in a way that N mod L=0.

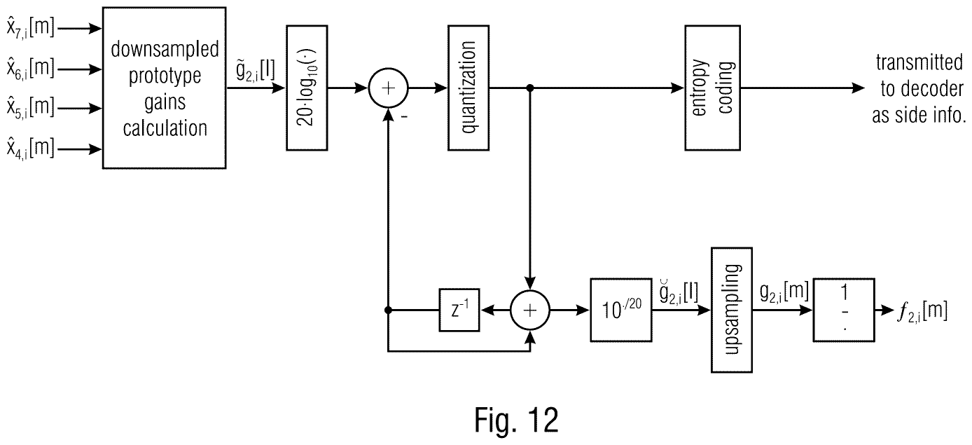

FIG. 12 illustrates an embodiment of an encoder side for transmitting prototype gains \tilde{g}_{ψ,i}[l] via DPCM for the subband signal group Ψ₂ defined with respect to FIG. 4 and FIG. 5.

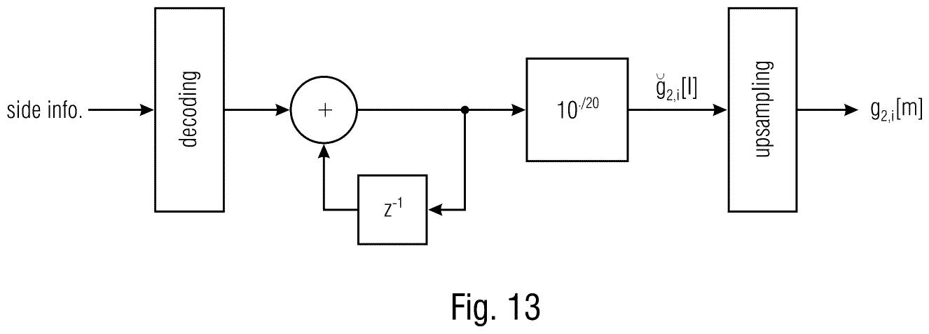

FIG. 13 illustrates an embodiment of a decoder side for transmitting prototype gains \tilde{g}_{ψ,i}[l] via DPCM for the subband signal group Ψ₂ defined with respect to FIG. 4 and FIG. 5, which corresponds to the embodiment of the encoder side depicted in FIG. 12.

As depicted in FIG. 12 and FIG. 13, these prototype gains are converted to dB and quantized via a DPCM scheme which is followed by entropy coding for transmission. At encoder and decoder, the downsampled reshaping gains \tilde{g}_{ψ,i}[l] are obtained via integration and conversion. The final reshaping gains g_{ψ,i}[l] can then be calculated via e.g. sample-and-hold upsampling

$${g}_{ψ , i} [ m ] = {\breve{g}}_{ψ , i} [ ⌊ m / D ⌋ ] . \qquad ( 25 )$$

The flattening gains are simply given as

$${f}_{ψ , i} [ m ] = {g}_{ψ , i}^{- 1} [ m ] .$$

Now, further concepts for coding the gains are briefly outlined:

According to an embodiment, a coding of g_{ψ,i}[m] via the method proposed in and

$${f}_{ψ , i} [ m ] = {g}_{ψ , i}^{- 1} [ m ]$$

is provided.

In an embodiment, a coding of g_{ψ,i}[m] via vector quantization and

$${f}_{ψ , i} [ m ] = {g}_{ψ , i}^{- 1} [ m ]$$

is provided.

According to an embodiment, in every frame i only coding of unwindowed gains u_{φ,i}[m] with m=0 . . . . N/2 corresponding to the right side of the transform window of frame i (overlapping with frame i+1). g_{ψ,i}[m] can then be calculated by concatenation of u_{ψ,i}[m] and u_{φ,i-1}[m] followed by a windowing.

In the following, time domain aliasing reduction is described.

It is well-known that all processing in the MDCT domain is inherently performed on a signal containing Time Domain Aliasing (TDA). While the TDA for the original signal is cancelled via Time Domain Aliasing Cancellation (TDAC) during the overlap-add process after the IMDCT, this does not apply to the quantization noise.

Therefore all temporal noise shaping happening in the MDCT domain underlies the TDA symmetry, unless countermeasures are applied. This effect is well known for the LPC based TNS method, where it can result in a pre-click artifact [12], and the same problem occurs for the methods described above. The influence of the TDA can be mitigated by using of a low-overlap window [13], which also relaxes the pre-click problem for TNS. However as the window influence applies full-band, this might reduce coding efficiency especially for signals containing not only transient but also tonal components.

In order to overcome above problem for TNS on subband signals and improve perceptual coding quality, TDAR [6] can be applied. This process can be interpreted as a temporal overlap-add process on the subband signals and therefore can be performed only in the frequency regions, where it is beneficial. The application of TDAR has to be signaled as side information (e.g. 1 bit for on/off) for each subband signal group and corresponds to the TDAR application to the right side (overlapping with the next frame) of the current window.

The TDAR operation has to be applied in the subband merging operation in the encoder and is then inverted during subband splitting in the decoder. As the TDAR and inverse TDAR operation requires the previous and the next spectrum to be available, it requires additional delay for obtaining the next MDCT spectrum both in encoder and decoder respectively.

If TDAR is used also any other processing between subband merging/splitting in the encoder and subband merging/splitting in the decoder benefit from the reduced TDA.

In the following, switching detection according to embodiments is described.

In order to avoid unnecessary application of the flattening/reshaping or TDAR a detection has to be carried out in the encoder to find out, whether to switch on/off the processing. This should be done in a way that results in best perceptual quality. In the following exemplary methods to achieve such a detection are proposed.

Now, switching detection for flattening/reshaping is described.

The decision whether flattening/reshaping should be applied depends on the temporal characteristics of the subband signals. It should only be performed for signals containing mostly transient components.

Now, an example via a temporal & spectral flatness measure on subbands is described.

A way to determine the temporal characteristics of a subband signal, is to use flatness measures as commonly used for evaluating spectral flatness [15]. This can be applied to the squared magnitude of each subband signal x_{ν,i} to obtain a temporal flatness measure TF_{ν,i} for each subband signal. A TF_{ν,i} of 1 indicates a constant temporal envelope, while a value closer to 0 indicates a more peaky/transient temporal envelope.

Using this, a decision can be made for each subband signal group. A simple detection algorithm could switch on the temporal noise shaping on the subband signal group Ψ_{ψ}, if

$${V}_{v ∈ {Ψ}_{ψ}} ( {TF}_{v , i} < tf\_threshold ) \qquad ( 26 )$$

evaluates to true. tf_threshold is an encoder tuning parameter.

In addition to that it is possible to calculate the spectral flatness SF_{ν,i} of each subband on the squared magnitude of X_{ν,i}[k] or X_{ν,i}[k]. A SF_{ν,i} of 1 indicates an atonal spectrum, while a value closer to 0 indicates a spectrum containing tonal components.

In combination with temporal flatness, this allows for a good classification of each subband regarding tonal and transient components in each subband. Especially avoiding to switch on temporal noise shaping for very tonal signals is beneficial. Therefore a simple detection algorithm using both temporal and spectral flatness could switch on temporal noise shaping if

$$[ {V}_{v ∈ {Ψ}_{ψ}} ( {TF}_{v , i} < tf\_threshold ) ] ∧ [ {V}_{v ∈ {Ψ}_{ψ}} ( {SF}_{v , i} > sf\_threshold ) ] \qquad ( 27 )$$

evaluates to true for subband signal group Ψ_{ψ}.

Now, an example via an AR model prediction gain is described.

Another method inspired by LPC based TNS is the AR model/LP prediction gain. The prediction gain is a measure to how well the AR model describes the original signal and can be calculated in the course of the Levinson-Durbin algorithm. If this measure is high, we can conclude that that the subband signal is rather transient and flattening/reshaping should be carried out. If it is low, no flattening/reshaping should be applied. Finding a suitable threshold for this decision is part of the encoder tuning.

As this approach requires the calculation of the spectral ACF and the result of the Levinson-Durbin algorithm, it is most suitable for the method for transmitting the gains based on AR modeling presented above, as these steps are performed already. Nevertheless it can also be applied for detection of the other methods, which then comes with additional computational complexity for calculating the spectral ACFs and the Levinson-Durbin algorithm.

Now, switching detection for TDAR is described.

The decision of whether to apply TDAR depends on how much influence the TDA inherent in the MDCT has on the subband signal and the noise shaping. A simple exemplary detection algorithm could perform TDAR and compare the subband signal with reduced TDA against the subband signal with TDA using e.g. a distance measure. If this indicates a large difference, TDAR could be switched on.

In the following, a number of temporal flatness measures are presented. These temporal flatness measures may, e.g., be employed to determine a flatness of a signal and/or its temporal envelope. Likewise, the temporal flatness measures may, e.g., be employed to determine a dynamic range of a signal. Simply spoken, in general, the flatter a signal is, the lower its dynamic range is.

Given a time domain signal

$$x [ n ] with n = 0 … N - 1 \qquad ( 28 )$$

the normalized squared magnitude (squared temporal envelope) may, e.g., be obtained as

$$p [ n ] = \frac{{\vert x [ n ] \vert}^{2}}{{\sum }_{n = 0}^{N - 1} {\vert x [ n ] \vert}^{2}} . \qquad ( 29 )$$

For a signal with an entirely flat temporal envelope

$$p [ n ] = \frac{1}{N} . \qquad ( 30 )$$

Based on that, the following measures for the temporal flatness of x[n] may, e.g., be defined. These flatness measures are maximized for a signal with an entirely flat envelope.

A classic flatness measure (CFM) may, e.g., be defined as follows:

$$CFM = \frac{Geometric Mean ofp [ n ]}{Arithmetic Mean ofp [ n ]} = \frac{\sqrt[N]{{\prod }_{n = 0}^{N - 1} p [ n ]}}{\frac{1}{N} {\sum }_{n = 0}^{N - 1} p [ n ]} \qquad ( 31 )$$

A normalized entropy may, e.g., be defined as follows:

$$H = {\sum }_{n = 0}^{N - 1} p [ n ] \cdot {log}_{n} ( p [ n ] ) \qquad ( 32 )$$

An entropy-based flatness measure (EFM) may, e.g., be defined as follows:

$$EFM = {2}^{H} - 1 = {2}^{[ - {\sum }_{n = 0}^{N - 1} p [ n ] \cdot {log}_{n} ( p [ n ] ) ]} - 1 \qquad ( 33 )$$

An MSE-based Flatness Measure (MSEFM) may, e.g., be defined as follows:

$$MSEFM = 1 - \frac{1}{N \cdot ( N - 1 )} {\sum }_{n = 0}^{N - 1} {( N \cdot p [ n ] - 1 )}^{2} \qquad ( 34 )$$

A difference-based flatness measure (DFM) may, e.g., be defined as follows:

$$DFM = \frac{1}{{\sum }_{n = 1}^{N - 1} \vert p [ n ] - p [ n - ] \vert} \qquad ( 35 )$$

A log-difference-based flatness measure (LDFM) may, e.g., be defined as follows:

$$LDFM = \frac{1}{{\sum }_{n = 1}^{N - 1} \vert log ( p [ n ] ) - log ( p [ n - ] ) \vert} \qquad ( 36 )$$

Regarding the dynamic range, the dynamic range of a signal x[n] with normalized squared temporal envelope p[n] as described above may, for example, be given by the ratio of the maximum value of p[n] and the minimum value of p[n]:

$$Dynamic Range = max ( p [ n ] ) / min ( p [ n ] )$$

Usually this value may, e.g., be converted to dB using 10·log 10 (Dynamic Range).

It may, e.g., be noted that the dynamic range may, e.g., be interpreted as an non-flatness measure, e.g., a flat/flattened envelope minimizes the dynamic range.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### ABBREVIATIONS

TNS Temporal Noise Shaping
MDCT Modified Discrete Cosine Transform
IMDCT Inverse Modified Discrete Cosine Transform
TDA Time Domain Aliasing
TDAC Time Domain Aliasing Cancellation
TDAR Time Domain Aliasing Reduction
LP Linear Prediction
LPC Linear Predictive Coding
ACF Autocorrelation Function
RCs Reflection Coefficients
AR Autoregressive
PCM Pulse Code Modulation
DPCM Differential Pulse Code Modulation
IGDFT Inverse Generalized Discrete Fourier Transform
RMS Root Mean Square

### REFERENCES

[1] B. Edler, “Codierung von Audiosignalen mit überlappender Transformation und adaptiven Fensterfunktionen,” Frequenz, vol. 43, no. 9, pp. 252-256, 1989.
[2] M. Bosi, K. Brandenburg, S. Quackenbush, L. Fielder, K. Akagiri, H. Fuchs, and M. Dietz, “ISO/IEC MPEG-2 advanced audio coding,” Journal of the Audio engineering society, vol. 45, no. 10, pp. 789-814, 1997.
[3] F. Ghido, S. Disch, J. Herre, F. Reutelhuber, and A. Adami, “Coding of fine granular audio signals using High Resolution Envelope Processing (HREP),” in 2017 IEEE International Conference on Acoustics, Speech and Signal Processing (ICASSP), pp. 701-705, IEEE, 2017.
[4] A. Biswas, P. Hedelin, L. F. Villemoes, and V. Melkote, “Temporal Noise Shaping with Companding,” in INTERSPEECH, pp. 3548-3552, 2018.
[5] J. Herre and J. D. Johnston, “Enhancing the performance of perceptual audio coders by using temporal noise shaping (TNS),” in Audio Engineering Society Convention 101, Audio Engineering Society, 1996.
[6] N. Werner and B. Edler, “Nonuniform orthogonal filterbanks based on MDCT analysis/synthesis and time-domain aliasing reduction,” IEEE Signal Processing Letters, vol. 24, no. 5, pp. 589-593, 2017.
[7] J. Princen, A. Johnson, and A. Bradley, “Subband/transform coding using filter bank designs based on time domain aliasing cancellation,” in ICASSP′87. IEEE International Conference on Acoustics, Speech, and Signal Processing, vol. 12, pp. 2161-2164, IEEE, 1987.
[8] R. Lefebvre and C. LaFlamme, “Shaping coding noise with frequency-domain companding,” pp. 61-62, 1997.
[9] J. Makhoul, “Linear prediction: A tutorial review,” Proceedings of the IEEE, vol. 63, no. 4, pp. 561-580, 1975.
ISO/IEC, “Information technology—Coding of audio-visual objects—Part 3: Audio.” International Standard 14496-3.
S. Korse, T. Jahnel, and T. Bäckström, “Entropy Coding of Spectral Envelopes for Speech and Audio Coding Using Distribution Quantization,” in Interspeech, pp. 2543-2547, 2016.
T. W. Chang, C. T. Chien, T. Chiou, Y. H. Hsiao, H. W. Hue, W. C. Lee, C. M. Liu, K. Y. Peng, and C. H. Yang, “Design of MPEG-4 AAC Encoder,” in Audio Engineering Society Convention 117, Audio Engineering Society, 2004.
E. Allamanche, R. Geiger, J. Herre, and T. Sporer, “MPEG-4 low delay audio coding based on the AAC codec,” in Audio Engineering Society Convention 106, Audio Engineering Society, 1999.
A. Gray and J. Markel, “A spectral-flatness measure for studying the autocorrelation method of linear prediction of speech analysis,” IEEE Transactions on Acoustics, Speech, and Signal Processing, vol. 22, no. 3, pp. 207-217, 1974.
N. Madhu, “Note on measures for spectral flatness,” Electronics letters, vol. 45, no. 23, pp. 1195-1196, 2009.

1-67. (canceled)

68. An apparatus for audio signal decoding, wherein the apparatus comprises:
a decoding unit configured for decoding an audio signal encoding to acquire a decoded spectral-domain audio signal and modification information, wherein the decoded spectral-domain audio signal comprises a plurality of spectral coefficients,
a first transform unit configured for transforming the decoded spectral-domain audio signal from a spectral domain to a subband signal domain to acquire a subband-signal-domain-transformed audio signal comprising a plurality of subband signals,
a subband signal modifier configured for acquiring a modified subband-signal-domain audio signal by modifying, depending on the modification information, one or more subband signals of the plurality of subband signals of the subband-signal-domain-transformed audio signal, and
a second transform unit configured for transforming the modified subband-signal-domain audio signal from the subband signal domain to the spectral domain to acquire a reconstructed spectral-domain audio signal.

69. An apparatus according to claim 68,
wherein the subband signal modifier is configured to modify the one or more subband signals by modifying, depending on the modification information, a temporal envelope of each of the one or more subband signals.

70. An apparatus according to claim 69,
wherein the subband signal modifier is configured to modify the temporal envelope of each of the one or more subband signals by reshaping the temporal envelope of said subband signal; or
wherein the subband signal modifier is configured to modify the one or more subband signals by modifying, depending on the modification information, a temporal envelope of each of the one or more subband signals, such that a dynamic range of each of the one or more subband signals is increased after being modified than before being modified; or
wherein the subband signal modifier is configured to modify the one or more subband signals by modifying, depending on the modification information, a temporal envelope of each of the one or more subband signals, such that a temporal flatness measure indicates that each of the one or more subband signals is flatter before being modified than after being modified.

71. An apparatus according to claim 69,
wherein the subband signal modifier is configured to employ a non-linear mapping curve to increase the dynamic range of said subband signal; or
wherein the modification information comprises information on an exponent α or information to determine the exponent α, wherein the subband signal modifier is configured to reshape the temporal envelope of said subband signal by applying an exponent β on a magnitude of samples of the subband signal, wherein β=α, and/or wherein β=1/α, and/or wherein β is derived from α; or
wherein the modification information comprises information on a received gain function or information to determine the received gain function; wherein the subband signal modifier is configured to reshape the temporal envelope of said subband signal by multiplying each sample of samples of the subband signal with a gain g of an applied gain function, or by multiplying each sample of the samples of the subband signal with 1/g, wherein g is a gain of an applied gain function; wherein the applied gain function is equal to the received gain function, or wherein the applied gain function is derived from the gain function.

72. An apparatus according to claim 68,
wherein the decoding unit is configured to acquire a plurality of reflection coefficients from the audio signal encoding,
wherein the subband signal modifier is configured to modify, depending on an autoregressive model, the one or more subband signals depending on the plurality of reflection coefficients.

73. An apparatus according to claim 68,
wherein the subband signal modifier is configured to determine a plurality of samples of a downsampled combined envelope for the one or more subband signals, before being modified,
wherein the subband signal modifier is configured to determine a plurality of gains using the plurality of samples of the downsampled combined envelope depending on a modification parameter,
wherein the subband signal modifier is configured to modify the one or more subband signals by applying the plurality of gains on the one or more subband signals, such that, after applying the one or more gains on the one or more subband signals, a dynamic range of the one or more subband signals is increased;
wherein the decoding unit is configured to acquire the modification parameter from the audio signal encoding.

74. An apparatus according to claim 68,
wherein the decoding unit is configured to acquire plurality of downsampled gains from the audio signal encoding, wherein the decoding unit is configured to acquire a plurality of applicable gains from the plurality of downsampled gains, such that the plurality of applicable gains represents an upsampling of the plurality of downsampled gains, wherein the subband signal modifier is configured to modify the one or more subband signals by applying the plurality of applicable gains on the one or more subband signals, such that the dynamic range of the one or more subband signals is increased; or
wherein the decoding unit is configured to acquire an indicator indicating a predefined mapping curve out of two or more predefined mapping curves, wherein the subband signal modifier is configured to acquire said predefined mapping curve, wherein the subband signal modifier is configured to modify, depending on said predefined mapping curve, the one or more subband signals; or
wherein the first transform unit is configured to transform the decoded spectral-domain audio signal from the spectral domain to the subband signal domain by conducting a first lapped transform to acquire the subband-signal-domain-transformed audio signal comprising the plurality of subband signals, wherein the second transform unit is configured to transform the modified subband-signal-domain audio signal from the subband signal domain to the spectral domain by conducting a second lapped transform to acquire the reconstructed spectral-domain audio signal.

75. An apparatus according to claim 68,
wherein the modification information comprises first modification information and second modification information, wherein the first modification information is different from the first modification information, wherein the subband signal modifier configured is configured to modify the one or more subband signals by conducting a modification of a first group of one or more subband signals of the plurality of subband signals of the subband-signal-domain-transformed audio signal according depending on the first modification information, and by conducting a modification of a second group of two or more subband signals of the plurality of subband signals of the subband-signal-domain-transformed audio signal depending on the second modification information, wherein the second group is different from the first group; or
wherein, when transforming the plurality of subband signal to the spectral domain, the second transform unit is configured to undo a time domain aliasing reduction operation conducted on an encoder side; or
wherein the audio signal encoding comprises a modification indication indicating whether or not a subband signal of the plurality of subband signals has been modified on an encoder side, wherein the subband signal modifier is configured to modify or to not modify said subband signal depending on the modification indication.

76. An apparatus according to claim 68,
wherein the subband signal modifier is configured to modify the one or more subband signals such that a dynamic range of each of the one or more subband signals is increased; or
wherein the spectral domain is a Modified Discrete Cosine Transform; or wherein
the spectral domain is a Modified Discrete Sine Transform; or
wherein the apparatus further comprises a spectral-to-time transform unit configured for transforming the reconstructed spectral-domain audio signal from the spectral domain to a time domain to acquire a reconstructed time-domain audio signal.

77. An apparatus for audio signal encoding, wherein the apparatus comprises:
a first transform unit configured for transforming a first spectral-domain audio signal comprising a plurality of spectral coefficients from a spectral domain to a subband signal domain to acquire a subband-signal-domain-transformed audio signal comprising a plurality of subband signals,
a subband signal modifier configured for modifying one or more subband signals of the plurality of subband signals of the subband-signal-domain-transformed audio signal to acquire a modified subband-signal-domain audio signal,
a second transform unit configured for transforming the modified subband-signal-domain audio signal from the subband signal domain to the spectral domain to acquire a modified spectral-domain audio signal, and
an encoding unit configured for generating an audio signal encoding which comprises an encoding of the modified spectral-domain audio signal and modification information or an encoding thereof, wherein the modification information comprises information on how the one or more subband signals have been modified.

78. An apparatus according to claim 77,
wherein the subband signal modifier is configured to modify the one or more subband signals by modifying, depending on the modification information, a temporal envelope of each of the one or more subband signals.

79. An apparatus according to claim 78,
wherein the subband signal modifier is configured to modify the temporal envelope of each of the one or more subband signals by flattening the temporal envelope of said subband signal; or
wherein the subband signal modifier is configured to modify the one or more subband signals by modifying, depending on the modification information, a temporal envelope of each of the one or more subband signals, such that a dynamic range of each of the one or more subband signals is reduced after being modified than before being modified; or
wherein the subband signal modifier is configured to modify the one or more subband signals by modifying, depending on the modification information, a temporal envelope of each of the one or more subband signals, such that a temporal flatness measure indicates that each of the one or more subband signals is flatter after being modified than before being modified; or
wherein the subband signal modifier is configured to flatten the temporal envelope of said subband signal by applying an exponent α on a magnitude of samples of the subband signal, wherein the modification information comprises information on the exponent α and/or comprises information to determine the exponent α and/or comprises information on 1/α or comprises information to determine 1/α; or
wherein the subband signal modifier is configured to flatten the temporal envelope of said subband signal by multiplying each sample of samples of the subband signal with a gain g of a gain function, wherein the modification information comprises information on the gain function or comprises information to determine the gain function and/or comprises information on a derived function comprising the gain 1/g for each gain g of the gain function and/or comprises information to determine the derived function.

80. An apparatus according to claim 77,
wherein the subband signal modifier is configured to determine a plurality of samples of a downsampled combined envelope for the one or more subband signals, before being modified,
wherein the subband signal modifier is configured to determine a plurality of gains using the plurality of samples of the downsampled combined envelope depending on a modification parameter,
wherein the subband signal modifier is configured to modify the one or more subband signals by applying the plurality of gains on the one or more subband signals, such that, after applying the one or more gains on the one or more subband signals, a dynamic range of the one or more subband signals is reduced;
wherein the encoding unit is configured to generate the audio signal encoding such that the audio signal encoding comprises the modification parameter or an encoding thereof.

81. An apparatus according to claim 77,
wherein the subband signal modifier is configured to determine a plurality of applicable gains for the one or more subband signals, such that by applying the plurality of applicable gains on the one or more subband signal, the dynamic range of the one or more subband signals is reduced, wherein the encoding unit is configured to determine a plurality of downsampled gains such that the plurality of downsampled gains represents a downsampling of the plurality of applicable gains, and wherein the encoding unit is configured to generate the audio signal encoding such that the audio signal encoding comprises the plurality of downsampled gains or an encoding thereof; or
wherein the subband signal modifier is configured to determine an indicator indicating a predefined mapping curve out of two or more predefined mapping curves for the one or more subband signals, before being modified, and wherein the encoding unit is configured to generate the audio signal encoding such that the audio signal encoding comprises the indicator or an encoding thereof, or
wherein the first transform unit is configured to transform the first spectral-domain audio signal from the spectral domain to the subband signal domain by conducting a first lapped transform to acquire the subband-signal-domain-transformed audio signal comprising the plurality of subband signals, wherein the second transform unit is configured to transform the modified subband-signal-domain audio signal from the subband signal domain to the spectral domain by conducting a second lapped transform to acquire the modified spectral-domain audio signal.

82. An apparatus according to claim 77,
wherein the subband signal modifier is configured to modify the one or more subband signals such that a dynamic range of each of the one or more subband signals is reduced; or
wherein the subband signal modifier is configured to determine a plurality of reflection coefficients from the one or more subband signals, before being modified, depending on an autoregressive model, wherein the encoding unit is configured to generate the audio signal encoding, such that the audio signal encoding comprises the plurality of reflection coefficients or an encoding thereof; or
wherein the spectral domain is a Modified Discrete Cosine Transform; or wherein the spectral domain is a Modified Discrete Sine Transform; or
wherein the apparatus further comprises a time-to-spectral transform unit configured for transforming a first time-domain audio signal from a time domain to a spectral domain to acquire the first spectral-domain audio signal; or
wherein the subband signal modifier configured is configured to modify the one or more subband signals by conducting a modification of a first group of one or more subband signals of the plurality of subband signals of the subband-signal-domain-transformed audio signal, and by conducting a modification of a second group of two or more subband signals of the plurality of subband signals of the subband-signal-domain-transformed audio signal, wherein the second group is different from the first group, and wherein the encoding unit is configured to generating the audio signal encoding which comprises the modification information or an encoding thereof, such that the modification information comprises first modification information and second modification information, wherein the first modification information depends on the modification of the first group of one or more subband signals, and the second modification information depends on the modification of the second group of two or more subband signals, wherein the first modification information is different from the second modification information; or
wherein the first transform unit is configured to conduct time domain aliasing reduction for generating one or more of the plurality of subband signals using a subsequent spectrum being subsequent to a current spectrum which comprises the spectral coefficients of the first spectral-domain audio signal; or
wherein the subband signal modifier is configured to conduct a determination determining whether or not to modify a subband signal of the plurality of subband signals of the subband-signal-domain-transformed audio signal depending on a signal characteristics of said subband signal, wherein the subband signal modifier is configured to modify or to not modify said subband signal depending on the determination, and wherein the encoding unit is configured to generate the audio signal encoding such that the audio signal encoding indicates whether or not the subband signal modifier has modified said subband signal.

83. A system comprising:
an apparatus for audio signal encoding, and
an apparatus for audio signal decoding according to claim 68,
wherein the apparatus for audio signal encoding apparatus for audio signal encoding comprises:
a first transform unit configured for transforming a first spectral-domain audio signal comprising a plurality of spectral coefficients from a spectral domain to a subband signal domain to acquire a subband-signal-domain-transformed audio signal comprising a plurality of subband signals,
a subband signal modifier configured for modifying one or more subband signals of the plurality of subband signals of the subband-signal-domain-transformed audio signal to acquire a modified subband-signal-domain audio signal,
a second transform unit configured for transforming the modified subband-signal-domain audio signal from the subband signal domain to the spectral domain to acquire a modified spectral-domain audio signal, and
an encoding unit configured for generating an audio signal encoding which comprises an encoding of the modified spectral-domain audio signal and modification information or an encoding thereof, wherein the modification information comprises information on how the one or more subband signals have been modified;
wherein the apparatus is configured to receive the audio signal encoding being generated by the apparatus for audio signal encoding.

84. A method for audio signal decoding, wherein the method comprises:
decoding an audio signal encoding to acquire a decoded spectral-domain audio signal and modification information, wherein the decoded spectral-domain audio signal comprises a plurality of spectral coefficients,
transforming the decoded spectral-domain audio signal from a spectral domain to a subband signal domain to acquire a subband-signal-domain-transformed audio signal comprising a plurality of subband signals,
acquiring a modified subband-signal-domain audio signal by modifying, depending on the modification information, one or more subband signals of the plurality of subband signals of the subband-signal-domain-transformed audio signal, and
transforming the modified subband-signal-domain audio signal from the subband signal domain to the spectral domain to acquire a reconstructed spectral-domain audio signal.

85. A method for audio signal encoding, wherein the method comprises:
transforming a first spectral-domain audio signal comprising a plurality of spectral coefficients from a spectral domain to a subband signal domain to acquire a subband-signal-domain-transformed audio signal comprising a plurality of subband signals,
modifying one or more subband signals of the plurality of subband signals of the subband-signal-domain-transformed audio signal to acquire a modified subband-signal-domain audio signal,
transforming the modified subband-signal-domain audio signal from the subband signal domain to the spectral domain to acquire a modified spectral-domain audio signal, and
generating an audio signal encoding which comprises an encoding of the modified spectral-domain audio signal and modification information or an encoding thereof, wherein the modification information comprises information on how the one or more subband signals have been modified.

86. A non-transitory digital storage medium having a computer program stored thereon to perform the method of claim 84 when said computer program is run by a computer.

87. A non-transitory digital storage medium having a computer program stored thereon to perform the method of claim 85 when said computer program is run by a computer.
